(19) United States
(12) Patent Application Publication
(10) Pub. No.: US 2014/0095262 A1
(43) Pub. Date: Apr. 3, 2014

(54) Sales system and business method including computer apparatus and product for and method of determining price

(71) Applicant: Patrick J. Barry, Huntington Beach, CA (US)

(72) Inventor: Patrick J. Barry, Huntington Beach, CA (US)

(73) Assignee: Real Time Software, Inc., Huntington Beach, CA (US)

(21) Appl. No.: 13/507,509

(22) Filed: Jul. 5, 2012

Related U.S. Application Data
(60) Provisional application No. 61/571,946, filed on Jul. 6, 2011.

(51) Int. Cl. G06Q 30/02; G06Q 50/08

(52) U.S. Cl. CPC G06Q 30/0206; G06Q 50/08
USPC 705/7.35

(57) ABSTRACT

A portable, handheld computer apparatus is used by a contractor's representative to determine the price of construction services at a job site in real time for presentation to a customer. Stored in a memory of the apparatus is data providing costs of a plurality of different construction materials used in building a structure at the customer's job site including at least some visual images of different construction materials to be displayed on the apparatus' display screen. This enables a customer to see the image and make a selection of materials while at the job site and after viewing the images. The apparatus has a program that based at least in part upon the specific materials selected by the customer and other information entered by the contractor's representative determines the total costs and a profit. The contractor's representative while at the job site and in real time may present a contract to the customer for the construction services.

### INCORPORATION BY REFERENCE

This application claims the benefit under 35 USC 119(e) of U. S. Provisional Patent Application No. 61/571,946, entitled “COMPUTER APPARATUS AND PRODUCT FOR AND METHOD OF DETERMINING PRICE,” filed Jul. 6, 2011. This related provisional application is incorporated herein by reference and made a part of this utility application. If any conflict arises between the disclosure of the invention in this utility application and that in the related provisional application, the disclosure in this utility application shall govern. Moreover, any and all U.S. patents, U.S. patent applications, and other documents, hard copy or electronic, cited or referred to in this application are incorporated herein by reference and made a part of this application, including discs containing an earlier version of my computer program product's source code submitted with the provisional patent application. Submitted herewith is a disc with a recent version of my computer program product's source code. Attached, as Appendix D, is a list of my computer program product's source code files contained on the submitted compact disc including their names, sizes in bytes, and dates of creation.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The words “customer” include anyone who is a prospective purchaser of goods or services as well as anyone who has in the past made a purchase.

The words “contractor's representative” include anyone with the actual or apparent authority to act on behalf of any supplier of goods or services or both, including their agents, employees, officers, distributors, or other representatives.

The word “contractor” includes any supplier of goods or services or both.

The words “substantially” and “essentially” have equivalent meanings.

### BACKGROUND

In many construction jobs it is typical for a customer to visit the contractor's office after the contractor's representative has first made an initial visit to the job site where the structure is to be built. The contractor's representative needs to first analyze the site and what type of structure is being built to determine what materials and/or components and services are required and what other information, if any, is needed to build the structure at the customer's job site. The contractor also needs to consider what local municipal building codes demand, make or modify written building plans and submit for approval to local governing agencies, and gather any other information needed to complete building the designated structure at the customer's chosen site. These factors bear on the type of services that will be needed for building the structure. For example, are the services of electricians, carpenters, plumbers, roofers, excavators, etc. required. Since there are numerous materials and components needed to build a designated structure that vary from one structure to another, each with varying specifications and many different brands of materials and components, the customer needs to make the final selection of the materials and components before the contractor can quote to the customer a price for doing the work. Although, there are many point of sale (POS) software programs available, none are specifically designed to give a contractor's representative the flexibility needed to adequately prepare and quote a firm price, in real time, at the job site for doing the required work.

### SUMMARY

My sales system and business method employ my portable, handheld y computer apparatus and computer program product for determining in real time the price of products, services, or both being offered, for example, construction services at a job site for presentation to a customer. My sales system and business method have one or more of the features depicted in the embodiment discussed in the section entitled “DETAILED DESCRIPTION OF ONE ILLUSTRATIVE EMBODIMENT.” The claims that follow define my sales system, business method, portable, handheld computer apparatus, and computer program product, distinguishing them from the prior art; however, without limiting the scope of my sales system, business method, portable, handheld computer apparatus, and computer program product as expressed by these claims, in general terms, some, but not necessarily all, of their features are:

One, my portable, handheld computer apparatus is adapted to determine the price of products or services or both at a job site in real time for presentation to a customer. The computer apparatus comprises an input device, a display screen, and a memory. The input device may be incorporated into the screen so that a selection of a good is made by touching an image of some good displayed on the screen. Moreover, as optional features, the size of an image can be increased or decreased, and the costs can be shown or hidden from view of a customer.

Two, the memory includes stored data providing costs of a plurality of different construction materials and/or components used in building a designated structure at a customer's job site. This data includes at least some visual images of different construction materials and/or components to be, upon selection, displayed on the display screen to enable a customer to see the image and make a selection of specific materials and/or components at the job site upon viewing the images.

Three, the computer apparatus also includes a program that based at least in part upon the specific materials and/or components selected determines a total cost and a profit, enabling a contractor's representative while at a job site and in real time to quote a price to the customer for the construction services. The program also enables the contractor's representative to enter other information about the job site and/or the designated structure as additional factors in determining the total cost and the profit.

Four, the computer apparatus may include means for enabling the contractor's representative to communicate with a remote back office computer for recording sales transactions in a memory of the back office computer. The back office computer may be programmed for managing types of goods and/or services being offered for sale and an inventory of goods, or for scheduling a meeting of a contractor's representative with a customer while the contractor's representative is at a location remote from the back office computer and the time and location of the scheduled meeting are displayed on the display screen, or both. The computer apparatus may include means for synchronizing the back office computer with the memory in the apparatus to update data in the memory in the apparatus. The means enabling the contractor's representative to communicate with the remote back office computer comprise a global computer network.

Five, in my sales system the portable, handheld computer apparatus is in communication with a remote back office computer to record sales transactions in a memory of the back office computer. The program enables the contractor's representative to enter other information about the job site and/or the designated structure as additional factors in determining the total cost and the profit. The back office computer is programmed for managing types of goods and/or services being offered for sale and an inventory of goods.

Six, my computer program product is for controlling my handheld, portable computer to execute a program that determines sales prices and comprises the following routines that

(a) enable a contractor's representative in real time at a meeting with a customer at a location remote from a contractor's office to offer for sale a combination of goods and services required to install or use the goods,

(b) enable a customer to view images of multiple goods and select one or more goods to be purchased, at least some of the selected goods having predetermined standard prices,

(c) calculate a total cost and a profit based at least in part on the predetermined standard prices, enabling a contractor's representative while at a job site and in real time to quote a sales price to the customer based at least in part upon a goods selected by a customer, and

(d) enable a contractor's representative to change the predetermined standard prices, whereby the contractor's representative has the ability to close a sale at the remote location in real time.
The computer product may include a routine that enables a contractor's representative to convert a quote into a firm price and a contract ready for a customer's acceptance. In my sales system at least some of the goods have associated therewith a standard description and the computer product includes a routine that enables a contractor's representative to change at least some of the standard descriptions.

Seven, my business method includes the step of providing a contractor's representative with a portable, handheld communication device and the contractor's representative meeting a customer at a job site where a designated structure is to be built. While at the job site, the representative using the communication device displays on the visual display for viewing by the customer images of the variety of different materials and/or components from which is selected the specific materials and/or components for building the designated structure at the job site. The customer while at the job site selects from the displayed images which specific materials and/or components that correspond at least in part to those to be used in building the designated structure. While at the job site, entering the customer's selection of materials and/or components into the communication device to determine a total cost and a profit, displaying on the visual display a price to enable the contractor's representative while at the job site and in real time to quote a price to the customer for the services to build the designated structure.

These features are not listed in any rank order nor is this list intended to be exhaustive.

### DESCRIPTION OF THE DRAWING

One embodiment of my computer apparatus and product for and method of determining the price of construction services at a job site are discussed in detail in connection with the accompanying drawing, which is for illustrative purposes only. This drawing includes the following figures (Figs.), with like numerals indicating like parts:

FIG. 1A is a diagram illustrating the current business method of interacting with a customer to determine the price of construction services.

FIG. 1B is a diagram illustrating my method of interacting with a customer to determine the price of construction services.

FIG. 2 is a schematic diagram showing the interaction of a contractor's representative at a job site and a contractor's back office in entering data in connection with sales of construction services.

FIG. 3 is schematic diagram of one embodiment of my computer apparatus

FIG. 3A is one example of a data tree.

FIG. 3B is one example of a data tree from my computer product.

FIG. 3C is a chart comparing the features of my point of sale computer product with other point of sale computer product.

FIG. 4 is a screen shot of my computer product launch page where the contractor logs into the application with a unique name and password.

FIG. 5 is a screen shot of my computer product where the contractor may select either the logout sub-menu or exit the application sub-menu.

FIG. 6 is a screen shot of the Configuration menu page of my computer product from where the contractor may select the sub-menus of either categories, unit of measure (UOM), products, barcode generation, or company details.

FIG. 7 is a screen shot of the categories sub-menu page of my computer product where the contractor may select and view the category list.

FIG. 8 is a screen shot of the categories sub-menu page of my computer product where the contractor may select and create a new category entry.

FIG. 9 is a screen shot of the units of measure sub-menu page of my computer product where the contractor may select and view the unit of measure list.

FIG. 10 is a screen shot of the units of measure sub-menu page of my computer product where the contractor may select and create a new unit of measure entry.

FIG. 11 is a screen shot of the products sub-menu page of my computer product where the contractor may select and view the products list.

FIG. 12 is a screen shot of the products sub-menu page of my computer product where the contractor may select and create a new product entry.

FIG. 13 is a screen shot of the barcode generation sub-menu where the contractor may select and generate a barcode for a product.

FIG. 14 is a screen shot of the company details sub-menu page of my computer product where the contractor may enter specific contractor information into the company details.

FIG. 15 is a screen shot of the Purchase menu page of my computer product where the contractor may select and view the purchase list sub-menu.

FIG. 16 is a screen shot of the purchase menu page of my computer product where the contractor may select and view the purchase entry sub-menu.

FIG. 17 is a screen shot of the Inventory menu page of my computer product where the contractor may select and view the stock adjustment sub-menu.

FIG. 18 is a screen shot of the Sale menu page of my computer product where the contractor may select the sale sub-menu and select and view the sale list.

FIG. 19 is a screen shot of the Sale menu page of my computer product where the contractor may select the sale sub-menu and select and create a sale entry.

FIG. 20 is a screen shot of the Sale menu page of my computer product where the contractor may select the quotation sub-menu and select and view the quotation list. FIG. 21 is a screen shot of the Sale menu page of my computer product where the contractor may select the quotation sub-menu and select and create a quotation entry. FIG. 22 is a screen shot of the Sale menu page of my computer product where the contractor may select the product selection sub-menu and view products from all categories.

FIG. 23 is a screen shot of the Sale menu page of my computer product where the contractor may select the product selection sub-menu and view goods from a specific category.

FIG. 24 is a screen shot of the Sale menu page of my computer product where the contractor has selected the quotation sub-menu and created a quotation entry for a specific customer.

FIG. 24A is a screen shot of the Sale menu page of my computer product where the contractor has selected the sale sub-menu and created a sale entry for a specific customer.

FIG. 25 is a screen shot of the top page of a quotation estimate to be printed or presented to the customer.

FIG. 25A is a screen shot of the top page of a sale contract to be printed or presented to the customer.

FIG. 26 is a screen shot of the middle page of a quotation estimate to be printed or presented to the customer.

FIG. 26A is a screen shot of the middle page of a sale contract to be printed or presented to the customer.

FIG. 27 is a screen shot of the bottom page of quotation estimate to be printed or presented to the customer.

FIG. 27A is a screen shot of the bottom page of sale contract to be printed or presented to the customer.

FIG. 28 is a screen shot of the Reports menu page of my computer product where the contractor may view the supplierwise purchase sub-menu.

FIG. 29 is a screen shot of the synchronization submenu page of my computer product.

FIG. 30 is a screen shot of a sale entry with a payment entry applied.

FIG. 31 is a screen shot of the payment list of my computer product.

FIG. 32 is a screen shot of the payment entry portion of my computer product.

FIG. 33 is a screen shot of the appointment entry portion of my computer product.

FIG. 34 is a screen shot of the of the appointment date and time entry portion of my computer product.

FIG. 35 is a screen shot of the select employee portion of my computer product.

FIG. 36 is a screen shot of the account follow up activity portion of my computer product.

FIG. 37 is screen shot of another account follow up activity portion of my computer product.

FIG. 38 is a screen shot of the payment processing screen showing the one touch email button of my computer product.

FIG. 39 is screen shot showing the use of another one touch email button of my computer product.

FIG. 40 is a screen shot of the customer's signature digitally captured by my computer product on a sales quotation estimate.

### DETAILED DESCRIPTION OF ONE ILLUSTRATIVE EMBODIMENT

### General

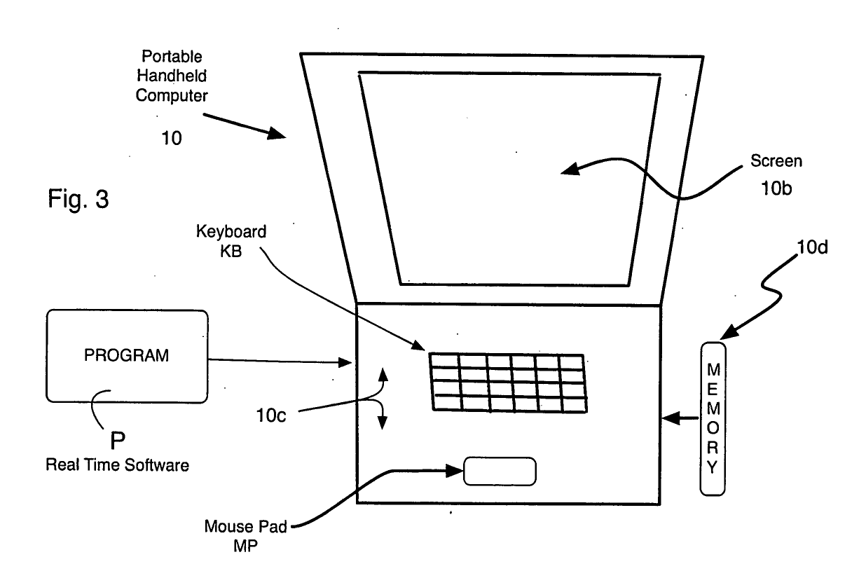

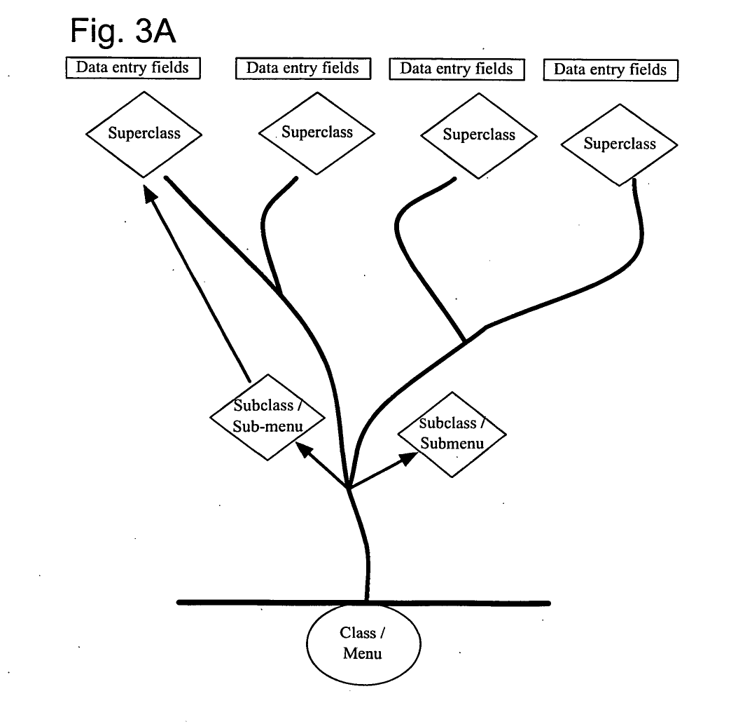

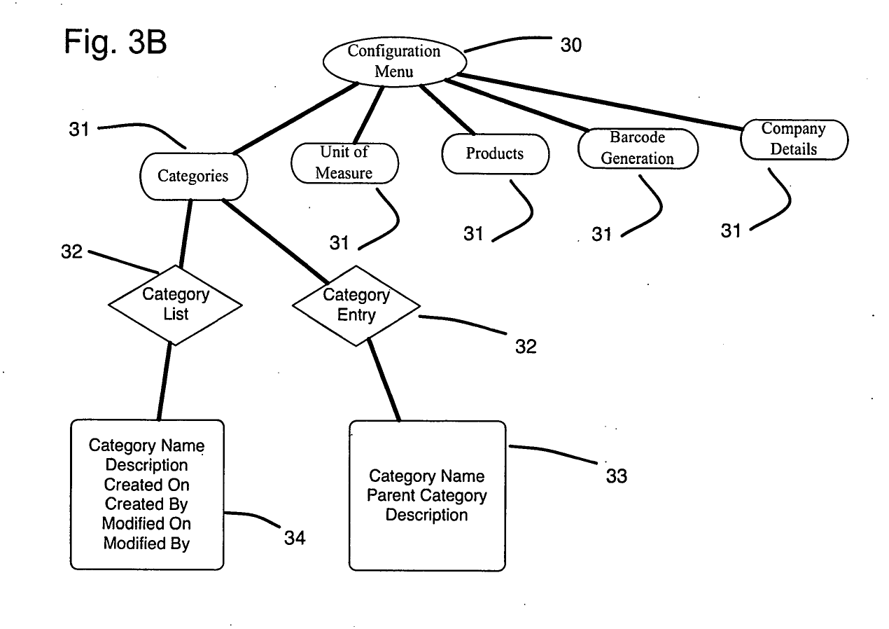

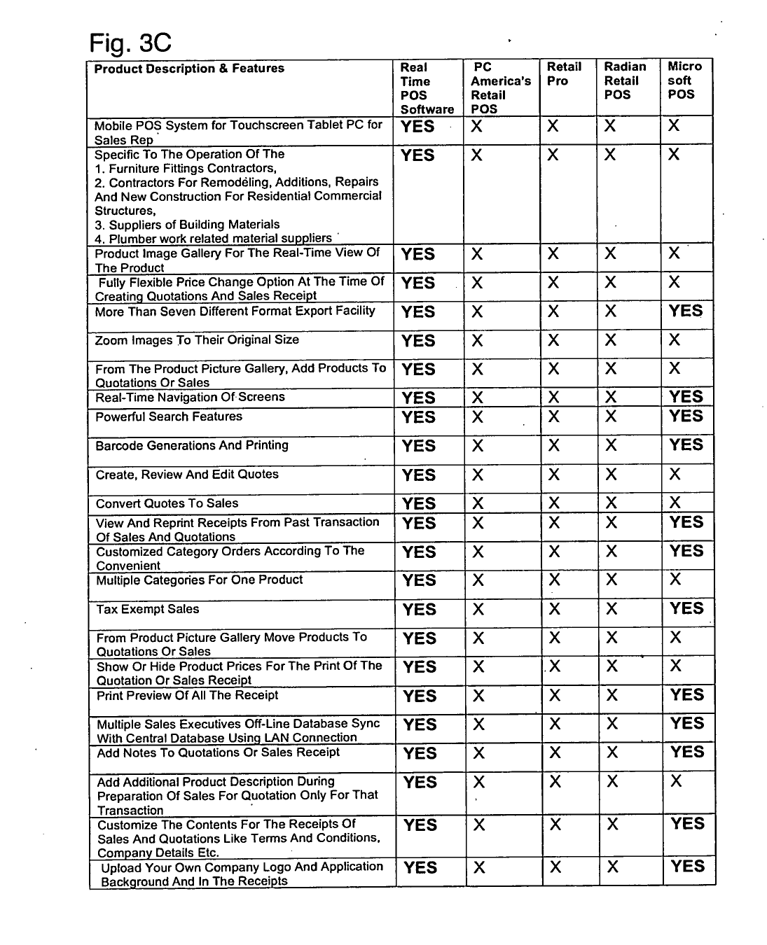

According to my business method a contractor's representative uses my portable, handheld computer apparatus 10 (FIG. 3) and my computer program product P to provide in real time a customer with a price quote to build at the customer's job site a customized designated structure.

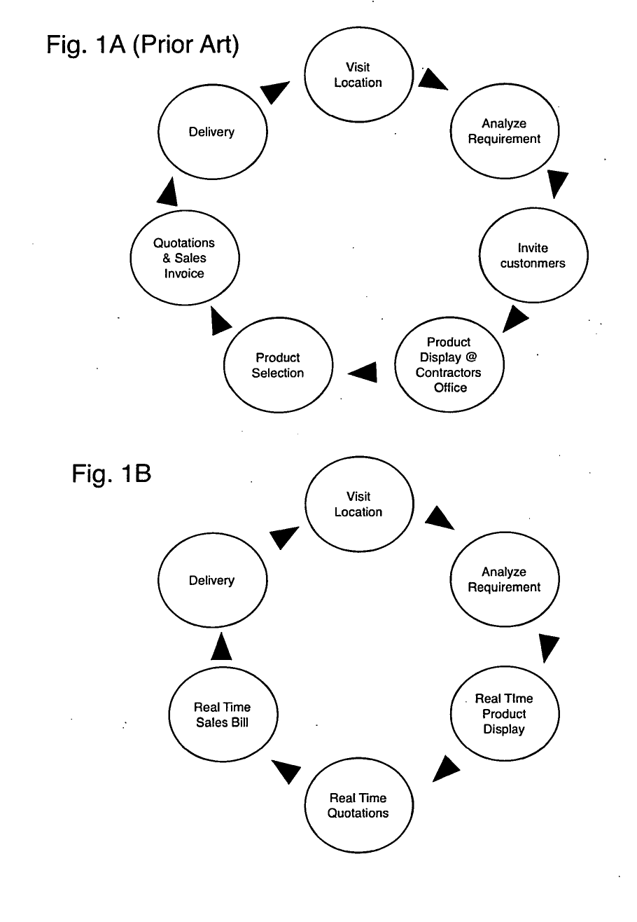

As depicted in FIG. 1A, the current method of providing quotes to customers requires the customer to meet the contractor's representative away from the job site at the contractor's office to review information about the materials and components used in building the designated structure at the job site. FIG. 1B depicts my business method that avoids going away from the job site to review information about the materials and/or components used and other matters in building a designated structure at the job site.

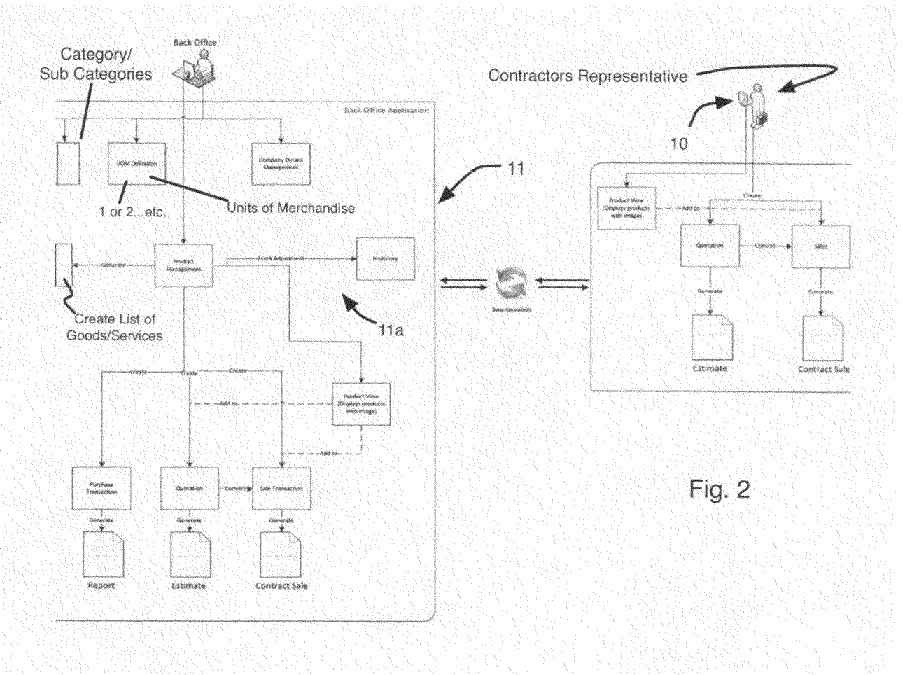

As illustrated in FIG. 2, my computer apparatus 10 may be, for example, a tablet personal computer (PC), a laptop PC, or other type of portable, handheld computer programmed using my real time adjustable point of sale computer program product entitled REAL TIME SOFTWARE. My computer program product, REAL TIME SOFTWARE, based at least in part upon the specific materials and/or components selected by a customer and other information about the job site and structure to be built thereat, determines for an individual job the total costs of goods and services and a profit in real time.

My computer apparatus 10 has a communication function that enables it to communicate with a remote back office system 11 at which costs and other alphanumeric and visual image data may be entered and configured into data trees 11a. For example, a product picture gallery along with product descriptions and associated prices, may be data that is downloaded or otherwise inputted into the computer apparatus 10 and/or the data trees 11a. This communication function may be a LAN connection or web-based system such as a wireless connection that enables the contractor's representative periodically to access updated point of sale information.

My apparatus 10 has a visual display screen 10b for showing to a customer text and images of a variety of different materials and/or components (e.g. products 230) for building a variety of different types of structures, an input device 10c such as a mouse pad and keyboard, and a memory 10d for storing data. The stored data may include costs of a variety of different construction materials and labor used in building a variety structures. The costs or data stored in the memory 10d may be inputted away from the job site as a central data back office function as depicted in FIG. 2. For example, images of plumbing fixtures may be entered into the back office system 11, and while at the customer's job site, the image of a faucet may be displayed on the screen 10b.

My computer apparatus 10 has a synchronization function that enables it to transmit and receive the data, for example, over the Internet by a wireless connection to the back office system 11. This data may be stored in the memory 10d and it includes at least some visual images of different construction materials and/or components to be, upon selection by the customer, displayed on the display screen 10b. This enables a customer at the job site to view images of a variety of possible materials and/or components and make a selection. Thus, the customer while at the job site selects from the displayed images those specific materials and/or components that are to be used at least in part in building the designated structure. Typical images of construction materials and/or components include, for example, lumber, flooring tiles, roofing, windows, doors, plumbing components, electrical components, carpeting, built-in furniture components, etc. Additionally, the synchronization function allows the contractor's representative to synchronize the representative's computer apparatus 10 with the back office system 11. The synchronization function will update the product details and available stock from the back office system 11 to the contractor's representative's computer apparatus 10 and will update quotation and sale details and customer appointments from the contractor's representative's computer apparatus 10 to the back office application 11.

The contractor's representative meets the customer at a job site where the designated structure is to be built. While at the job site, the contractor's representative uses my computer apparatus 10 and my computer program product to, in real time, display for viewing by the customer the images of a variety of different materials and/or components from which the designated structure may be built at the job site. The contractor's representative while at the job site and using the input device 10c typically enters the customer's selection of materials and/or components into my computer apparatus 10. The computer program product REAL TIME SOFTWARE determines the total costs of goods and services and a profit, displaying on the visual display screen 10b a price to enable the contractor's representative, while at the job site and in real time, to quote this price to the customer for the goods and services required to build the designated structure. The program REAL TIME SOFTWARE has fully flexible price change options enabling the contractor's representative to adjust a quotation or sale price, if in the judgment of the contractor's representative, it is desirable or necessary to change the cost to make the sale. In other words, the contractor's representative is not necessarily locked into the back office price setting. The customer selects from a list of the displayed goods and services those specific goods and services corresponding to the ones to be used in the construction of the designated structure at the site after viewing several images. The program REAL TIME SOFTWARE has the ability to add additional descriptions to a selected product during preparation of an individual sale quotation or sale contract. Likewise, the contractor's representative is not necessarily locked into the back office product description and may input additional product description to clarify what the customer requires.

My business method enables the contractor's representative while at the job site and in real time to present a sale quotation or sale contract to the customer for the construction goods and services. This quotation or sale contract may be a hard copy document that is printed up by a portable printer accompanying the contractor's representative or it may be an electronic document displayed on the visual display screen 10b with an accept button that the customer actuates to indicate his or her acceptance of the terms of the contract or it may be an electronic document displayed on the visual display screen 10b which the customer may directly sign their signature onto the display screen 10b via a touch screen input device 10c. Additionally, once a sale is complete the contractor's representative can take a form of payment from the customer to start the job. For example, the contractor's representative can ask for ten percent of the total cost of the job and set up a payment plan allowing for multiple payments to be entered on the same account.

### Real Time Software Application

My computer program product comprises a number of routines that provide several features. The chart depicted in FIG. 3C compares features available in my computer program product with features in other point of sale programs, such as Microsoft® Dynamic POS, pc America® Retail POS Software, Retail Pro®, and Radiant Retail Pro. A check mark indicates the presence of a feature and “X” indicates the absence of a feature. As indicated in FIG. 3C my computer program product has several features that are lacking in the other point of sale programs. The most important features of my point of sale program are that it:

(a) enables a contractor's representative in real time at a meeting with a customer at a location remote from a contractor's office to offer for sale a combination of goods and services required to install or use the goods,

(b) enables a customer to view product images of multiple goods for selection and addition to the sale quotation or sale contract, at least some of the selected goods having predetermined standard prices,

(c) calculates a total cost and a profit based at least in part on the predetermined standard prices, enabling a contractor's representative while at a job site and in real time to quote a sales price to the customer based at least in part upon goods selected by a customer, and

(d) enables a contractor's representative the flexibility to change the predetermined standard prices of goods and services, whereby the contractor's representative has the ability to close a sale at the remote location in real time.

(e) enables a contractor's representative the flexibility to edit sale quotations by adding or deleting goods or services and then converting the sale quotation into a sale contract.

(f) enables a contractor's representative to change a standard description associated with goods and/or services.

(g) enables a contractor's representative to convert a sale quote into firm a price and a sale contract ready for a customer's acceptance.

(h) enables a contractor's representative accounting functions to take a form and amount of payment from the customer to start the job and then record further payments towards the completion of the job.

(i) enables a contractor's representative to synchronize data between the handheld portable computer apparatus 10 and the back office system 11.

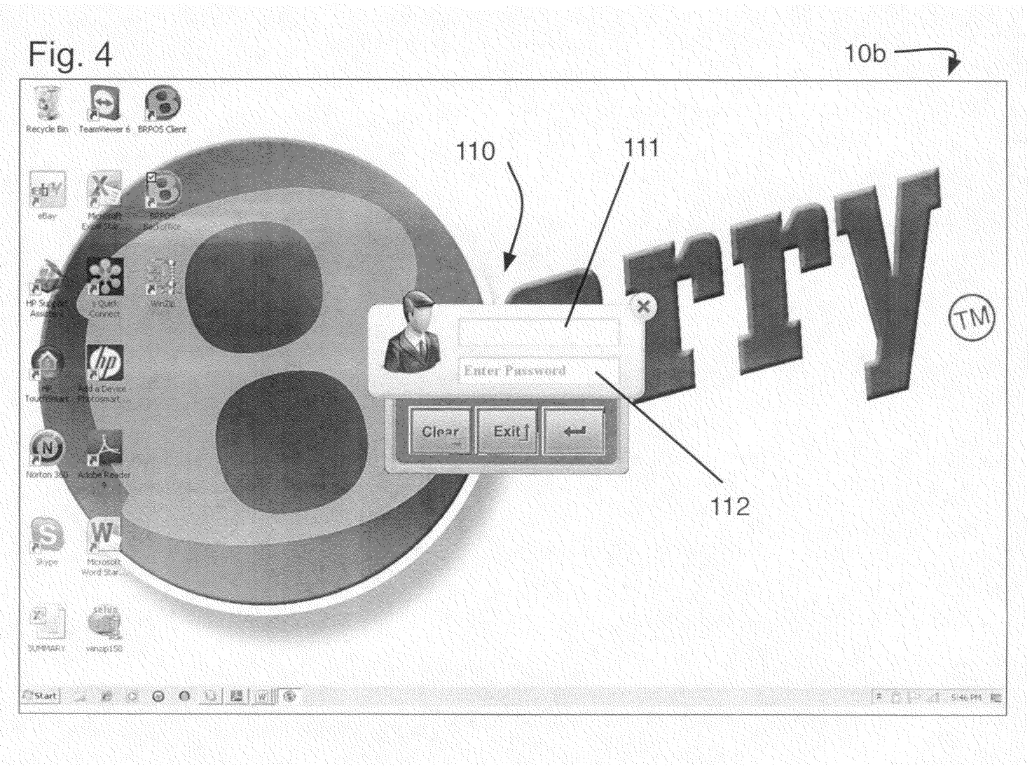

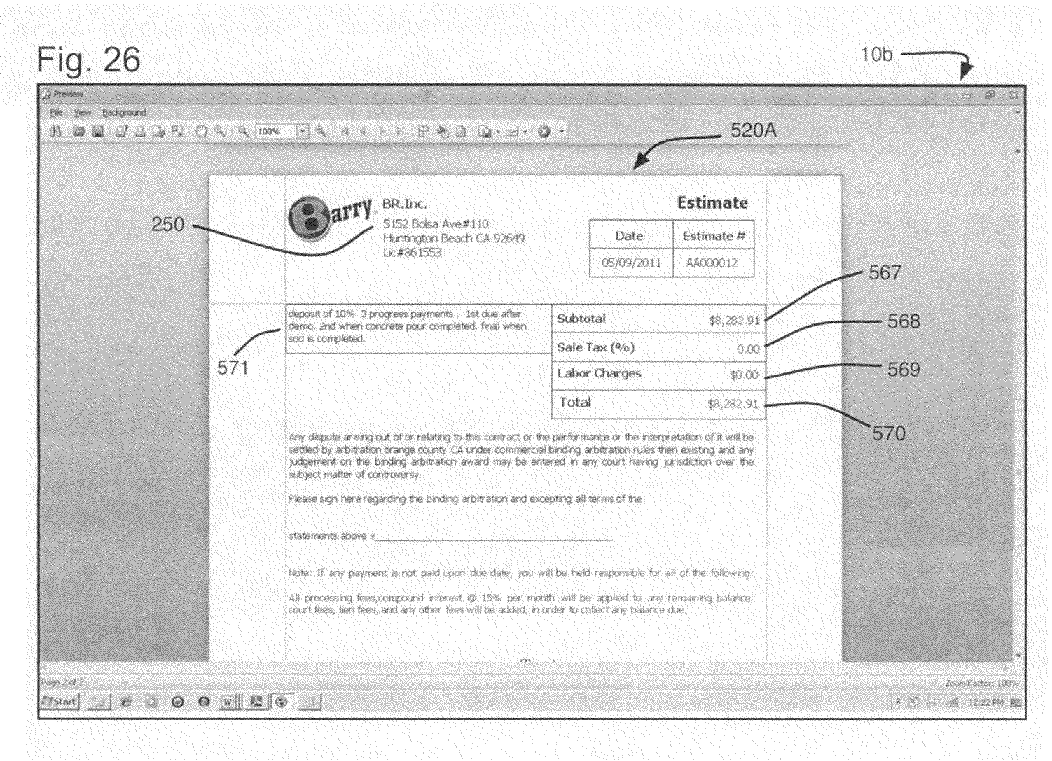

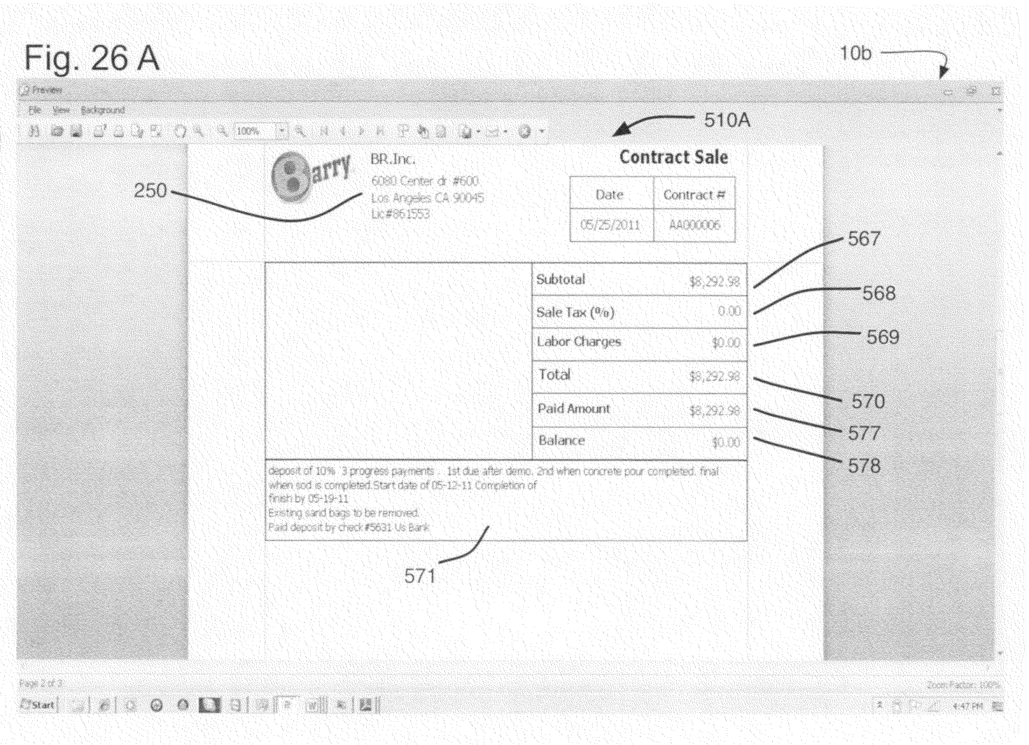

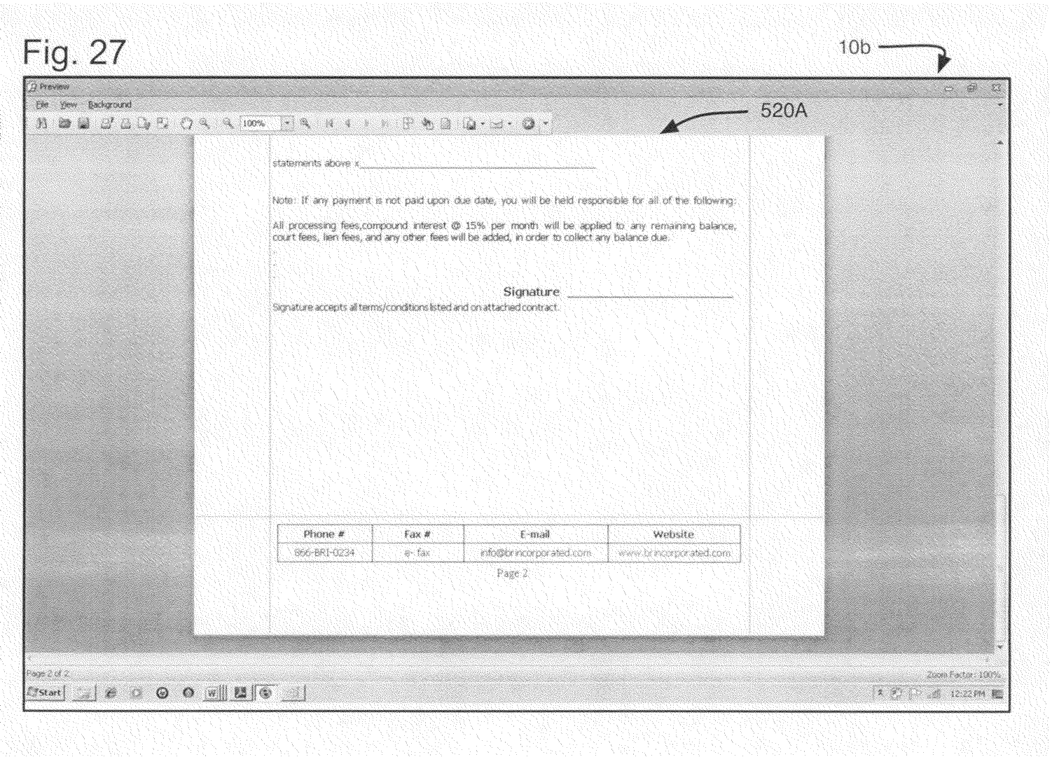

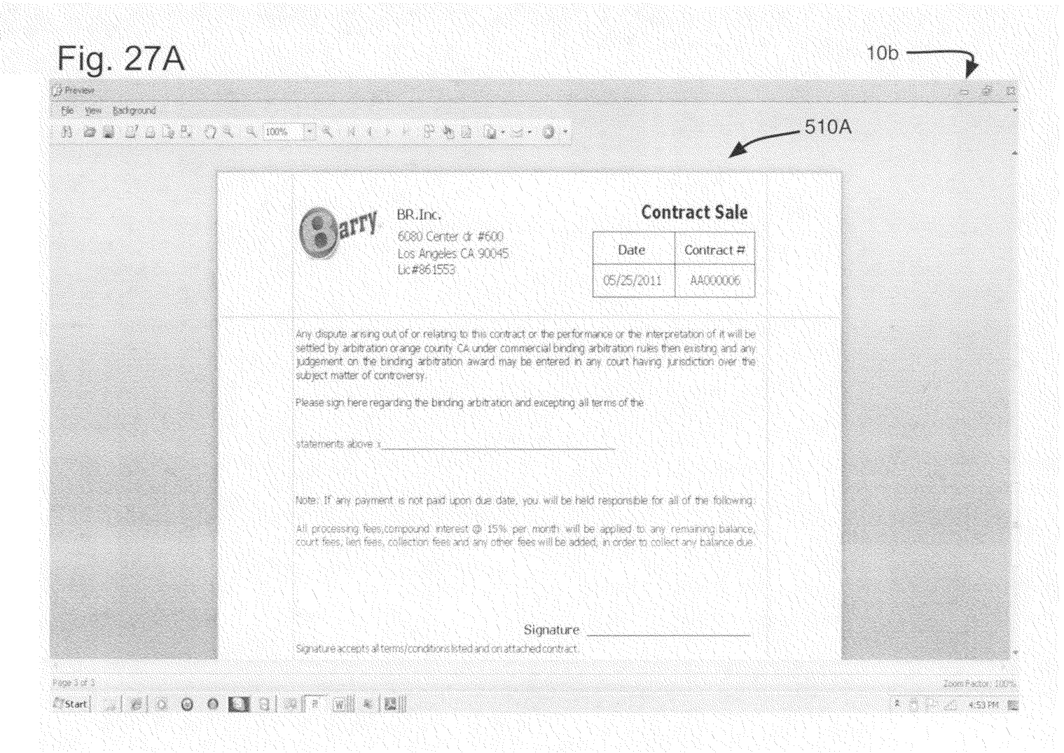

FIGS. 4 through 40

The FIGS. 4 through 40 illustrate my computer program product. My computer product may be any physical instrument that stores a set of source code instructions and interfaces with a computer hardware device allowing a user to execute a program according to the source code instructions. These instructions determine in real time the price of the job, that is, the costs of the goods and/or services and profit, to create or modify a sale estimate or sale contract for presentation to a customer.

In the embodiment discussed below, my computer program product itself was developed using: Visual Studio 2010 (Microsoft® .Net Framework 4.0), SQL server 2008, Synchronization Framework (Synchronization-v2.1), Dev Express Controls Library (DXperience-10.1.6), Coding Language: C#, and Software Design Pattern: MVVM.

The Microsoft® .NET Framework is a software framework development tool running on Microsoft® Windows® operating system. The Microsoft®.NET Framework allows the developer to build and run software applications and XML Web services interfacing with a computer hardware device. The Microsoft®.NET Framework includes a large library and supports several programming languages allowing for language interoperability. Programs written for the Microsoft/NET Framework execute in a software, known as the Common Language Runtime (CLR), an application virtual machine that provides security, memory management, and exception handling services. The class library and the CLR together constitute the Microsoft/NET Framework. Programmers produce software by combining their own source code with the Microsoft®.NET Framework and other libraries. The Microsoft®.NET Framework platform software program itself is programmed and modified by following the deployment and installation instructions set forth in Appendix A. Additionally, the computer program listing appendix submitted on compact discs, is the source code for my computer program product.

The developed source code itself provides the application REAL TIME SOFTWARE program to allow the user to organize alphanumeric and visual image data then manipulate such data in real time for the purpose of creating, editing, saving, or deleting a variety of sales quotations or sales contracts. To draft a sale quotation or sale contract the user, in real time, uses a touch screen computer apparatus or an input device 10c to manipulate their organized data through such standard operational functions of an add button 700, edit button 701, delete button 702, export button 703, save button 704, save print button 705, refresh screen button 706, cancel button 707, and close screen button 708.

The user's data is inputted, configured, and displayed in permutations of data trees. As illustrated in FIG. 3A an example of a data tree starts with a main class (menu) branching out to a sub-class (sub-menus) then towards a specific superclass with specific data tree entry fields. The date tree entry fields are specifically where the user configures their data by inputting alphanumeric or image data. As illustrated in FIG. 3B, a more detailed example of my computer program products data tree organization shows the main menu configuration 30 which allows the user to accesses the sub menus 31 of either categories, unit of measure, goods, barcode generation, or company details. When a user accesses the sub-menu 31 of categories they can then choose to accesses the specific superclass 32 of either categories list or category entry. The user can then input pertinent data into the category entry data tree fields 33 and retrieve the organized data in the category list data tree fields 34.

In the embodiment depicted, my computer program product is installed in any handheld or portable computer capable of communication and synchronization with the contractor's back office system 11, for example, over the Internet or a LAN connection. My computer program product may be tangibly “burnt’ onto a disk, or simply an application program download over the Internet. Furthermore, my computer program product being illustrated by the following example is not limited to this specific example, and may be used in any sales situation as a real time point of sale (POS) application.

### Real Time Software Application Configuration

My computer program product's source code allows a contractor's representative in real time to create, edit, save, delete, visually display, print, email, fax, schedule an appointment with a customer, syncronize data between a portable handheld computer device and a back office computer system, and account for payments of a variety of sales quotations or sales contracts for a designated job while at the customer's job site. FIGS. 4 through 40 shows a series images appearing on the display screen 10b of my handheld portable computer apparatus 10 as the contractor's representative interacts with the customer at the job site in real time to prepare and present a sale quotation or sale contract to complete the building of a designated structure for the customer. Prior, however, to a contractor's representative being able to create or modify in real time such a sale quotation or sale contract, my computer program product must be configured to reflect the contractor's specific goods and/or services, for example a general construction contractor's goods and associated labor. Thus, once my computer program product's data trees are configured, through entering data into specific data entry fields, such configured data advantageously allows the contractor's representative to easily create, edit, save, delete, modify, visually display, print, email, fax, a sales estimate or contract in real time for a customer while at the customer's job site.

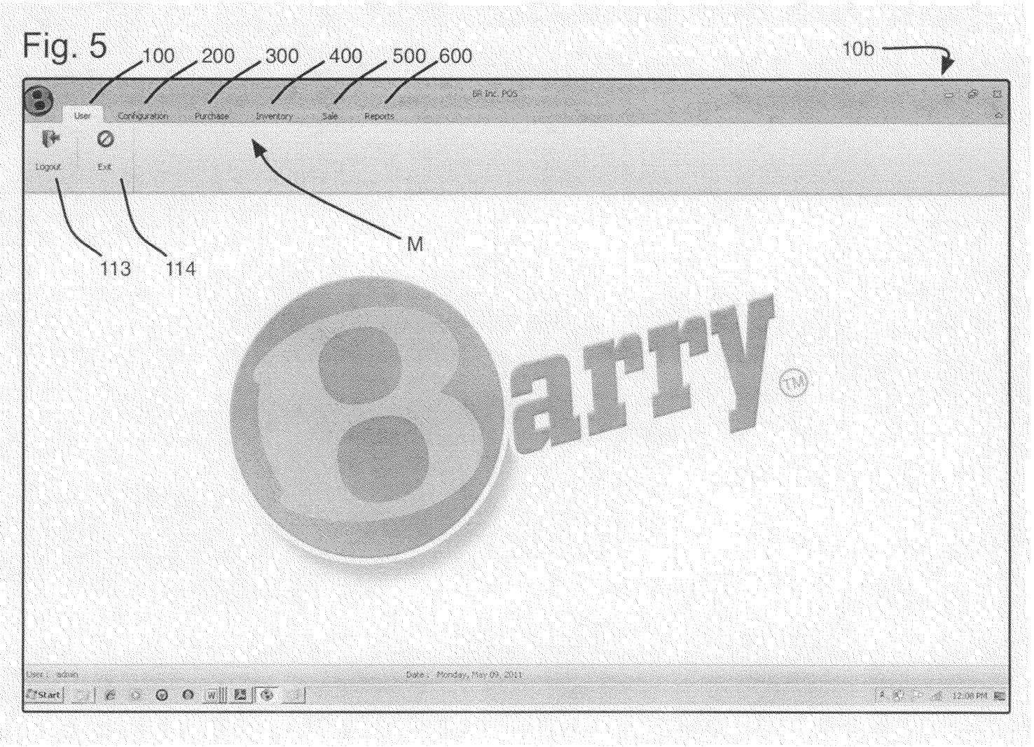

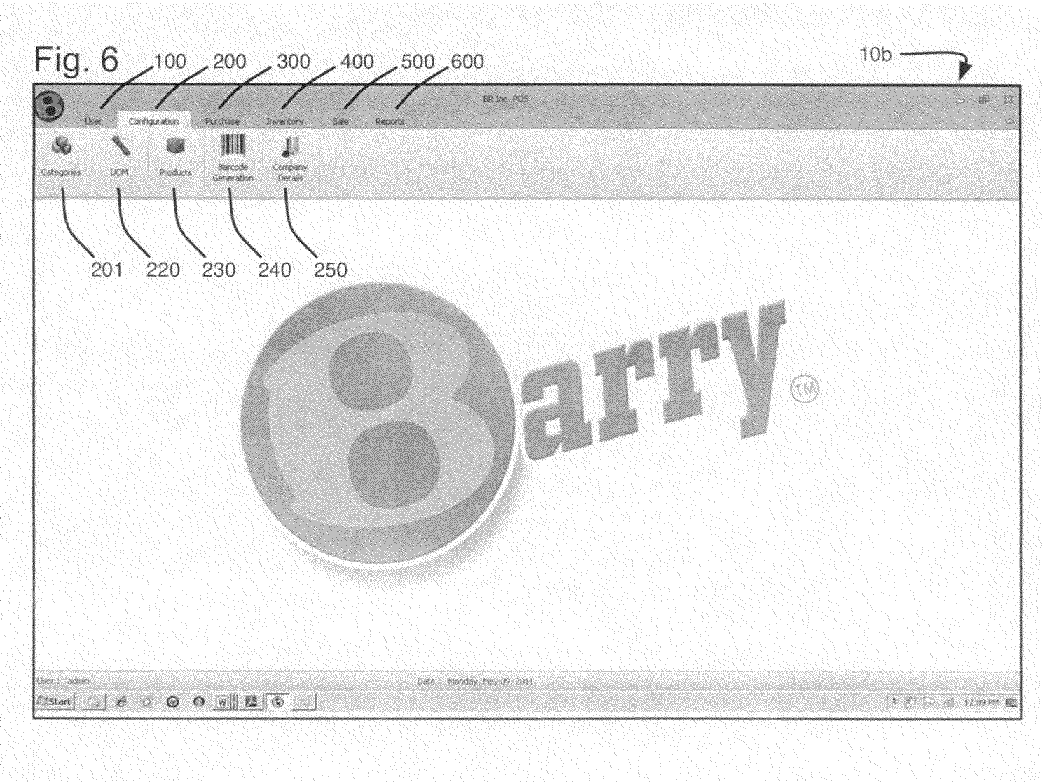

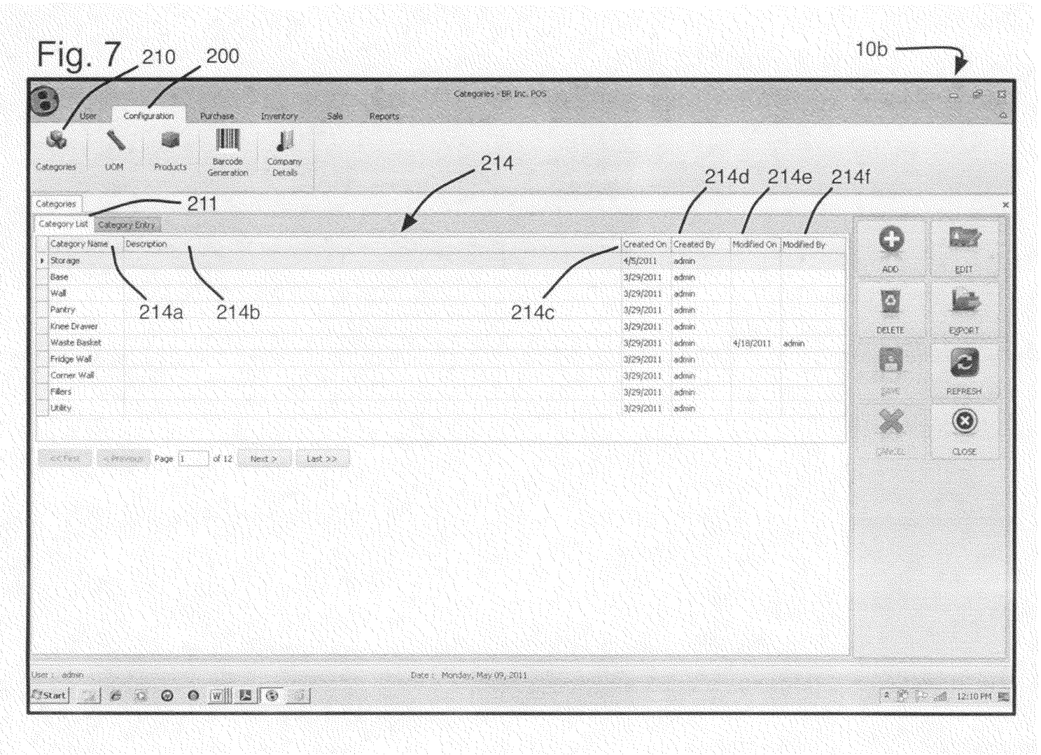

FIG. 4 shows the image on the screen 10b upon opening my computer program product. As illustrated in FIG. 5, my computer program product includes a main class data tree menu M comprising User Menu 100, Configuration Menu 200, Purchase Menu 300, Inventory Menu 400, Sale Menu 500, and Reports Menu 600. As illustrated in FIG. 6, the Configuration Menu 200 of my computer program product has the data tree sub-menus of categories 201, unit of measure (UOM) 220, goods 230, barcode generation 240, and company details 250. These configuration sub-menus 201, 220, 230, 240, 250 allow one to access specific data tree fields and input alphanumeric and/or visual image data thereby and configuring my computer program product to specifically reflect a particular company's goods and/or services. Thus, once a specific contractor's data is entered and configured into my computer program's data tree entry fields, functions such as real time creation, editing, saving, or deletion of a variety of sale quotation or sale contract can occur.

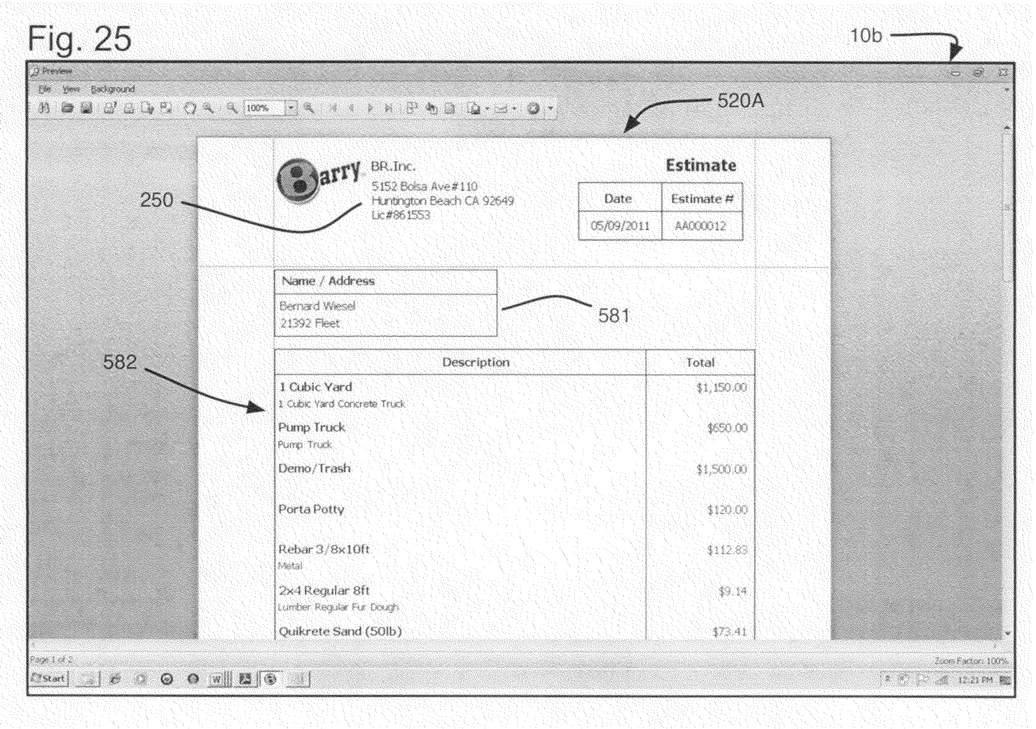

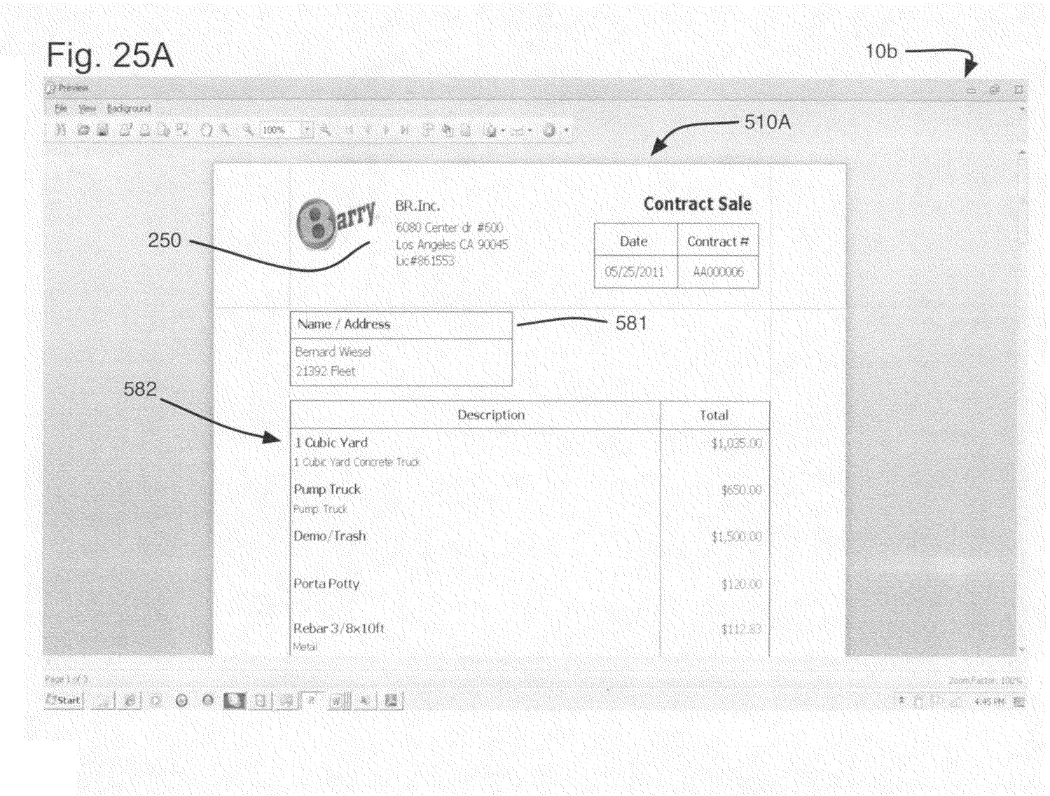

As illustrated in FIG. 14, the Configuration Menu 200 contains the company details sub-menu 250. Upon selecting the company details sub-menu 250 a user can access the company entry superclass 260. The company entry superclass 260 contains the company entry data tree fields 251 which allow a user to configure their company details by inputting or importing such pertinent data into the company name field 251a, address field 251b, phone number field 251c, fax number field 251d, email address field 251e, website address field 251f, company logo field 251g, and other miscellaneous information field 251h; for example, contractual language as set forth in Appendix B. Additionally, as illustrated in FIG. 14, the operational functions of the save button 704, refresh button 706, and close button 708 allow a user to interface with my computer program product and complete the configuration of the company details sub-menu 250. As shown in FIGS. 25 and 25A, the data entered into the company entry data tree fields 251 will be displayed in the company detail field 250 on the final sale quotation or sale contract.

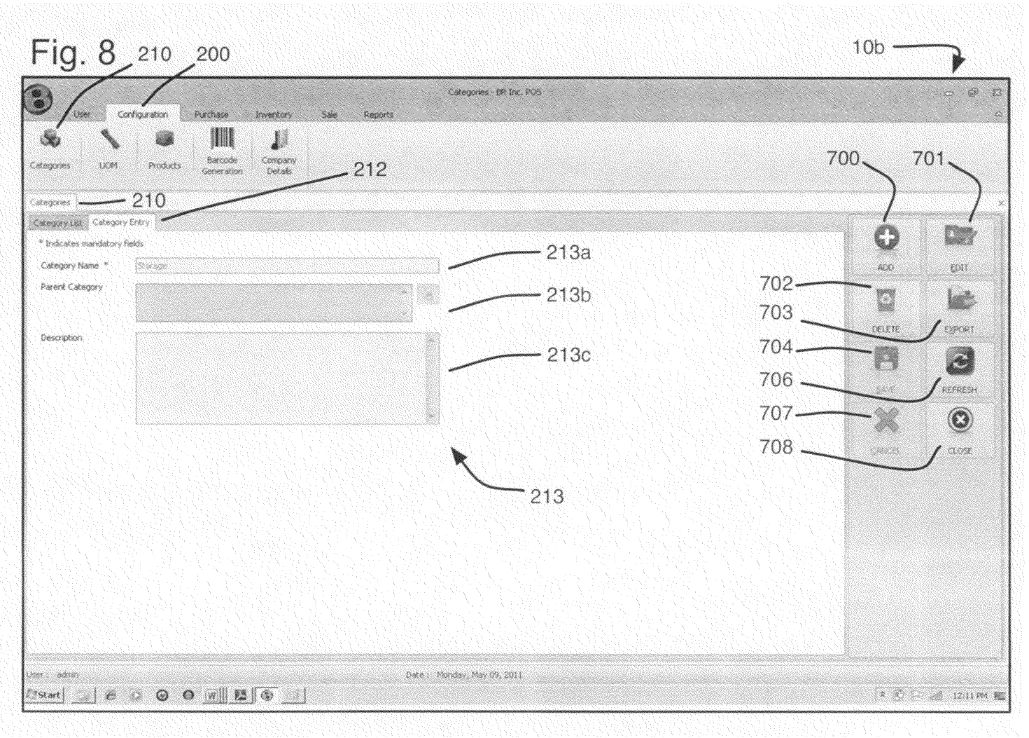

As illustrated in FIG. 8, the Configuration Menu 200 contains the categories sub-menu 210. Upon selecting the categories sub-menu 210 the user can access the category entry superclass 212. The category entry superclass 212 contains the category entry data tree fields 213 which allow a user to configure their specific goods and/or services by inputting or importing such pertinent data into the category name field 213a, parent category field 213b, and description field 213c. Additionally, as illustrated in FIG. 8, while in the category entry superclass 212 a user can perform operational functions by actuating the add button 700 to add another category entry, edit button 701 to edit a category entry, delete button 702 to delete a category entry, export button 703 to export a category entry, save button 704 to save a category entry, refresh button 706 to refresh the category entry on the screen 10b, cancel button 707 to cancel inputting a category entry, or the close button 708 to close the category entry on the screen 10b.

As illustrated in FIG. 7, the Configuration Menu 200 contains the category list sub-menu 211. The category list 211 is compiled from the specific data entered into the category entry data tree fields 213 (FIG. 8). The category list 211 displays the category list data tree fields 214 of category name field 214a, description field 214b, created on date field 214c, created by whom field 214d, modified on date field 214e, and modified by whom field 214f.
The category list sub-menu 211 allows a contractor's representative or customer to view a complete list of all the contractor's configured categories. The categories themselves become the broad tasks associated with completing a job at the customer's location. For example, to facilitate generating a real time quotation or sale contract for re-modeling a kitchen, the contractor would configure my computer program product to include such categories as cabinets, plumbing, and appliances.

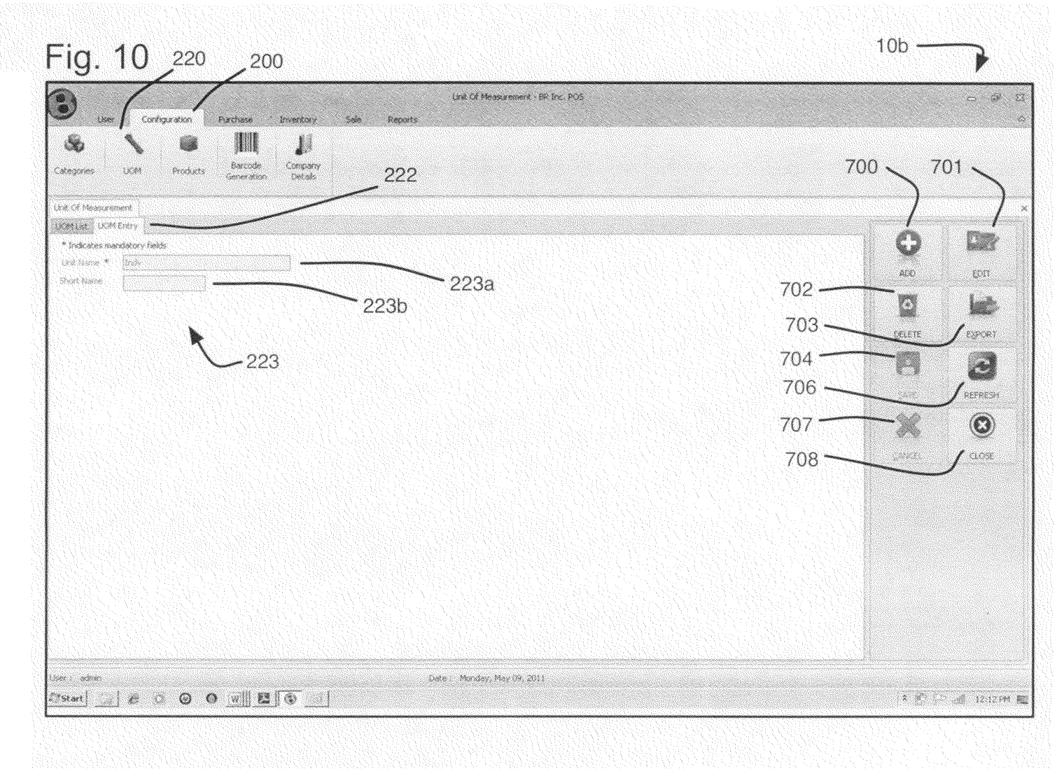

As illustrated in FIG. 10, the Configuration Menu 200 contains the unit of measure (UOM) sub-menu 220. Upon selecting the UOM sub-menu 220 a user can access the UOM entry superclass 222. The UOM entry superclass 222 contains the UOM entry data tree fields 223 which allow a user to configure their various goods and/or services by inputting or importing such pertinent data into the unit name field 223a, and short name field 223b. The UOM 220 is a goods dependant identifier that can be configured to designate goods as, for example, a single piece, a dozen pieces, or a case. Additionally, as illustrated in FIG. 10, while in the UOM entry superclass 222 a user can perform operational functions by actuating the add button 700 to add another UOM entry, edit button 701 to edit a UOM entry, delete button 702 to delete a UOM entry, export button 703 to export a UOM entry, save button 704 to save a UOM entry, refresh button 706 to refresh the UOM entry on the screen 10b, cancel button 707 to cancel a UOM entry, or the close button 708 to close the UOM entry on the screen 10b.

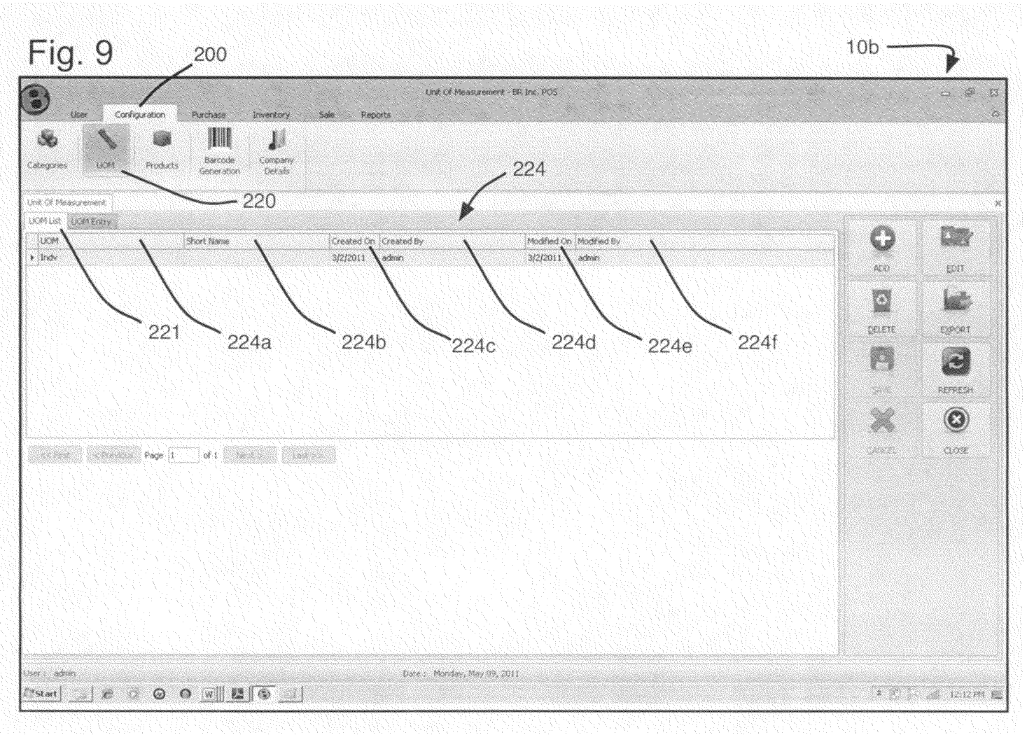

As illustrated in FIG. 9, the Configuration Menu 200 contains a UOM list sub-menu 221. The UOM list 221 is compiled from the specific data entered into the UOM entry data tree fields 223 (FIG. 10). The UOM list 221 displays the UOM list data tree fields 224 of UOM field 224a, short name field 224b, created on date field 224c, created by whom field 224d, modified on date field 224e, and modified by whom field 224f. The UOM list 221 allows a contractor's representative to view a complete list of products having a unit of measure identifier.

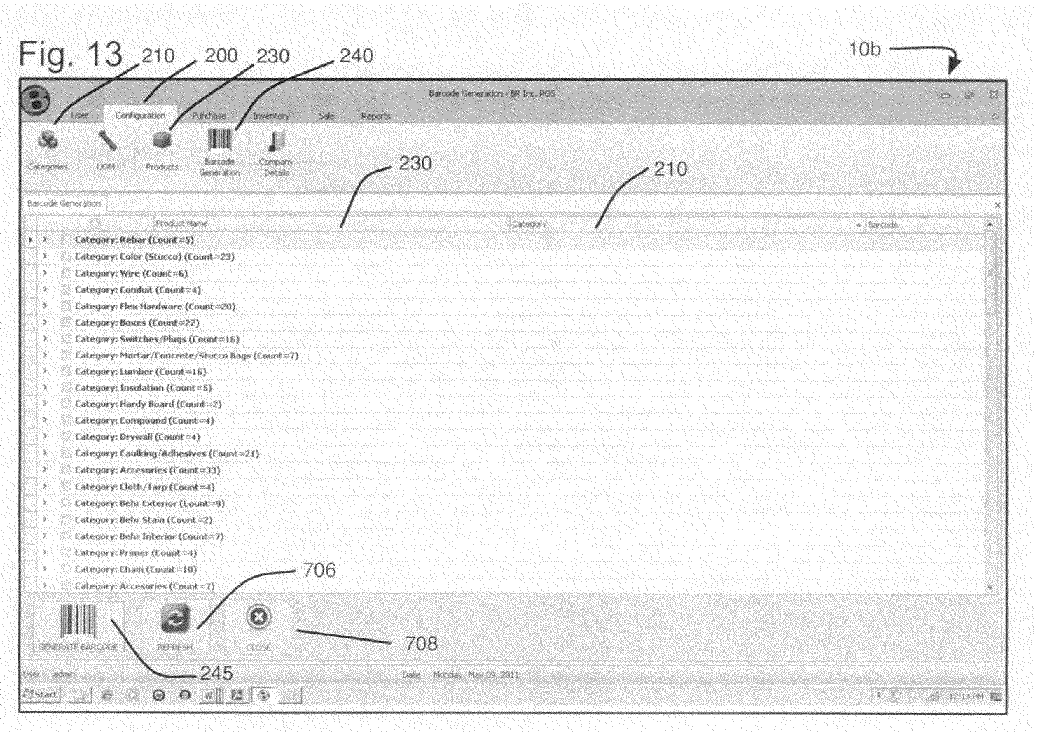

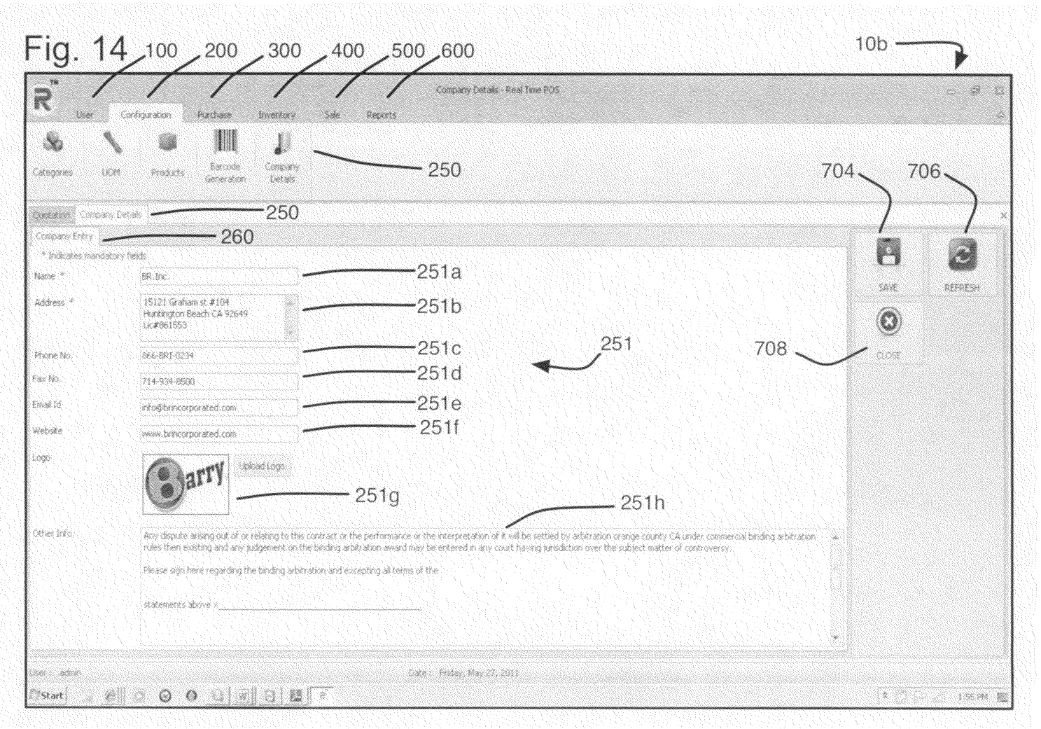

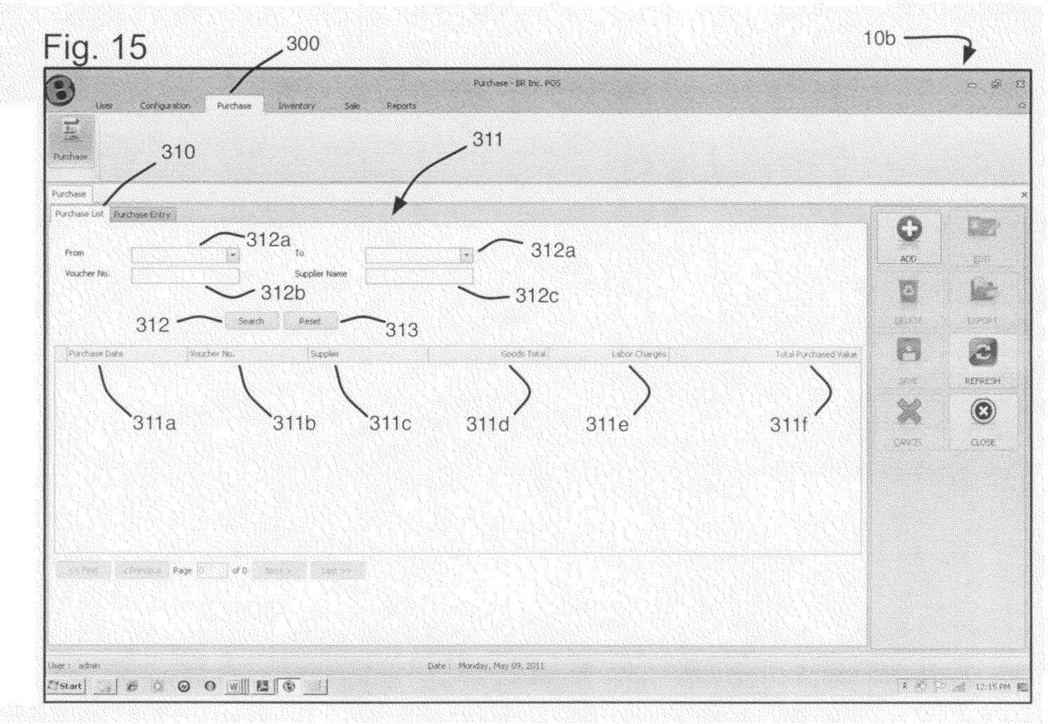

As illustrated in FIG. 13, the Configuration Menu 200 contains the barcode generation sub-menu 240. The barcode generation sub-menu 240 allows the contractor to organize and track their categories 210 and/or their products 230 by generating a barcode 245 or other wise inputting or importing a unique barcode for individual categories or products. This feature allows the contractor's representative to know what goods are in stock and allows for easier ordering of goods from a supplier. Additionally, as illustrated in FIG. 13, while in the barcode generation sub-menu 240 the contractor can perform operational functions by actuating the refresh button 706 to refresh the barcode generation on the screen 10b, or the close button 708 to close the barcode generation on the screen 10b.

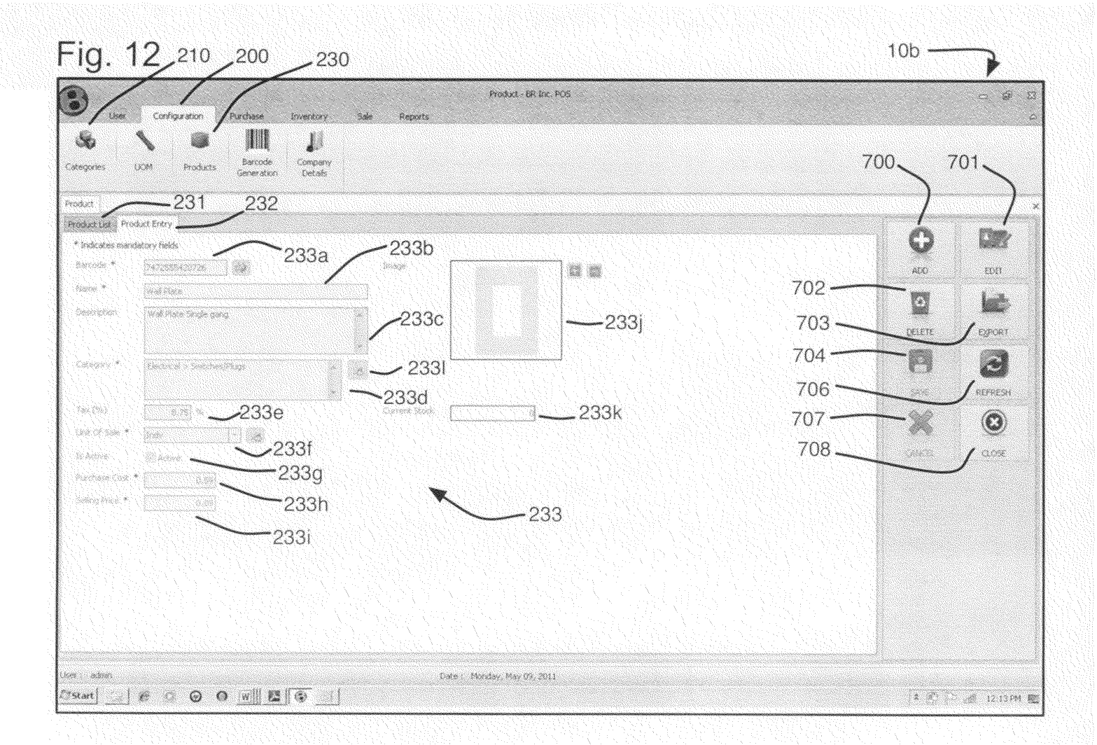

As illustrated in FIG. 12, the Configuration Menu 200 contains the products sub-menu 230. Upon selecting the products sub-menu 230 the user can access the product entry superclass 232. The product entry superclass 232 contains the product entry data tree fields 233 which allow a user to configure their specific goods and/or services by inputting or importing such pertinent data into barcode field 233a, name field 233b, description field 233c, category 233d field, tax (%) field 233e, unit of sale field 233f, is active field 233g, purchase cost field 233h, selling price field 233i, product image field 233j, and current stock field 233k. A product may be organized into a single category in the category field 233d or the user may organize the product into multiple categories by accessing the add category field 233l. Additionally, as illustrated in FIG. 12, while in the product entry superclass 232 a user can perform operational functions by actuating the add button 700 to add another product entry, edit button 701 to edit a product entry, delete button 702 to delete a product entry, export button 703 to export a product entry, save button 704 to save a product entry, refresh button 706 to refresh the product entry on the screen 10b, cancel button 707 to cancel a product entry, or the close button 708 to close the product entry on the screen 10b. The products themselves are the goods and/or services required to compete a task selected from the category list 211 of the category sub-menu 210. For example, to facilitate generating a real time quotation or sale contract for painting a house, the contractor would configure my computer program product to include such products as paint, paintbrushes and the services of a painter.

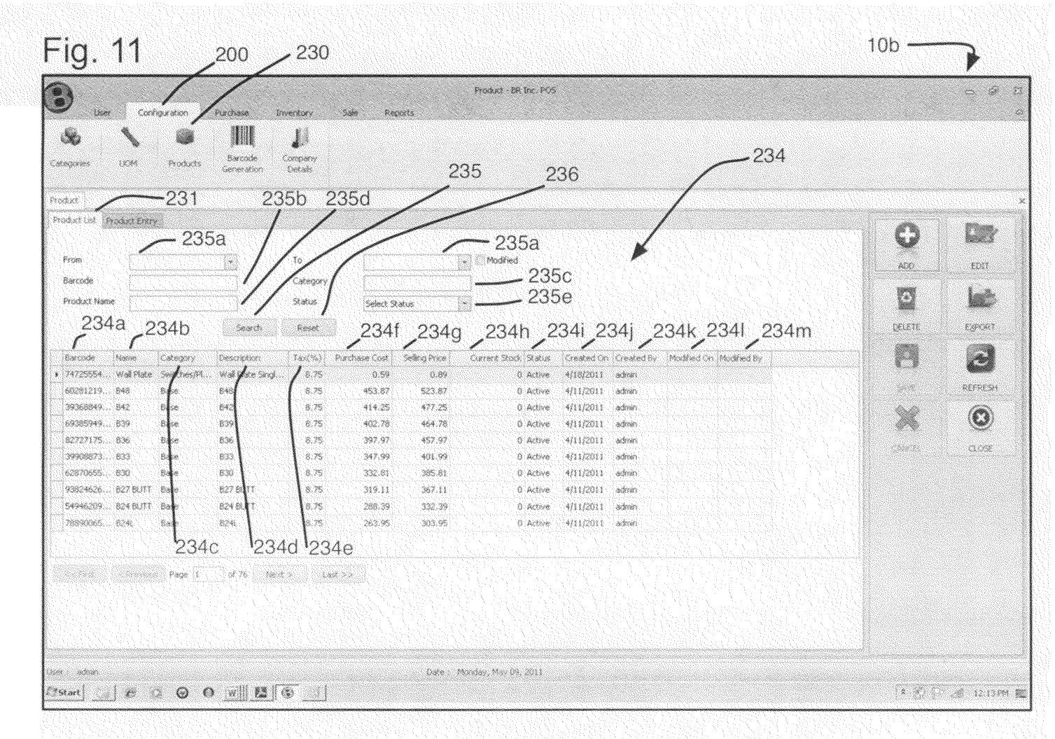

As illustrated in FIG. 11, the products sub-menu 230 contains the product list 231. The product list 231 is compiled from the specific data entered into the product entry data tree fields 233 (FIG. 12). The product list 231 displays the product list data tree fields 234 of barcode field 234a, name field 234b, category field 234c, description field 234d, tax (%) field 234e, purchase cost field 234f, selling price field 234g, current stock field 234h, status field 234i, created on date field 234j, created by whom field 234k, modified on date field 234l, and modified by whom field 234m. The product list 231 allows a contractor's representative or customer to view a complete list of products (goods and/or services) required to complete a customer's job. A contractor's user, either a back office administrator or a contractor's representative, can initiate a search 235 for products in real time by entering information into the search fields of from/to creation date range field 235a, barcode number field 235b, category name field 235c, product name field 235d, or status field 235e. A user may also reset a search 236 and enter in varied search information.

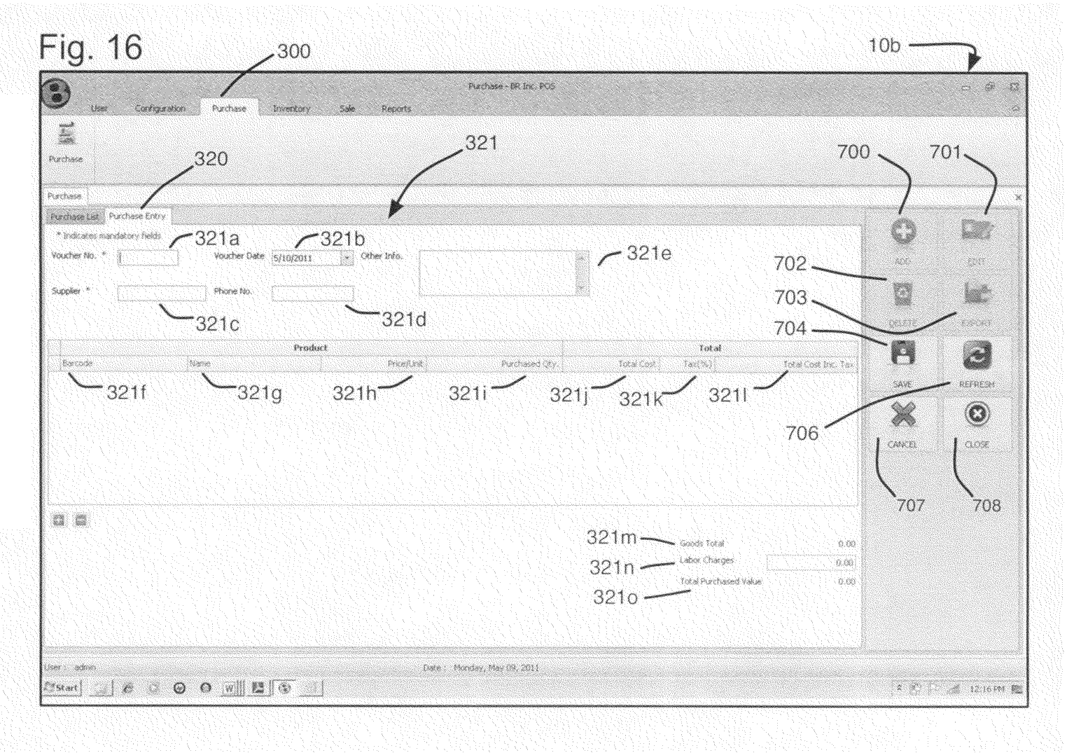

As illustrated in FIG. 16, the Purchase Menu 300 contains the purchase entry sub-menu 320. The purchase entry sub-menu 320 allows the contractor's representative to create a purchase entry order for a good from a listed supplier identified in the field 321c. The contractor's representative makes such a purchase order through entering specific data into the purchase entry data tree fields 321 of voucher number field 321a, voucher date field 321b, supplier field 321c, phone number field 321d, and other information field 321e. After the specific supplier information is entered the required goods can be selected and the goods' barcode identified in the field 321f, name in the field 321g, and price per unit in the field 321h will be displayed in the purchase entry sub-menu 320. The contractor's representative can then enter the purchased quantity in the field 321i and the total cost in the field 321j, tax (%) in the field 321k, and total cost including tax in the field 321l, will be calculated in real time. Likewise, once a the purchase entry data tree fields 321f-321l are completed my computer program product will calculate in real time the goods total in the field 321m, labor charges in the field 321n, and total purchased value in the field 321o. Additionally, as illustrated in FIG. 16, while in the purchase entry sub-menu 320 a user can perform operational functions by actuating the add button 700 to add another purchase entry, edit button 701 to edit a purchase entry, delete button 702 to delete a purchase entry, export button 703 to export a purchase entry, save button 704 to save a purchase entry, refresh button 706 to refresh the purchase entry on the screen 10b, cancel button 707 to cancel a purchase entry, or the close button 708 to close the purchase entry on the screen 10b.

As illustrated in FIG. 15, the Purchase Menu 300 contains the purchase list sub-menu 310. The purchase list sub-menu 310 is compiled from the specific data entered into the purchase entry data tree fields 321 (FIG. 16). The purchase list 310 displays the purchase list data tree fields 234 of purchase date field 311a, voucher number field 311b, supplier field 311c, goods total field 311d, labor charges field 311e, and total purchased value field 311f. The purchase list 231 allows a contractor's representative to view a complete list of products (goods and/or services) attained to complete a customer's job. A contractor's user, either a back office administrator or a contractor's representative, can initiate a search 312 for purchases in real time by entering information into the search fields of from/to creation date range field 312a, voucher number field 312b, and supplier name field 312c. A user may also reset a search 313 and enter in varied search information.

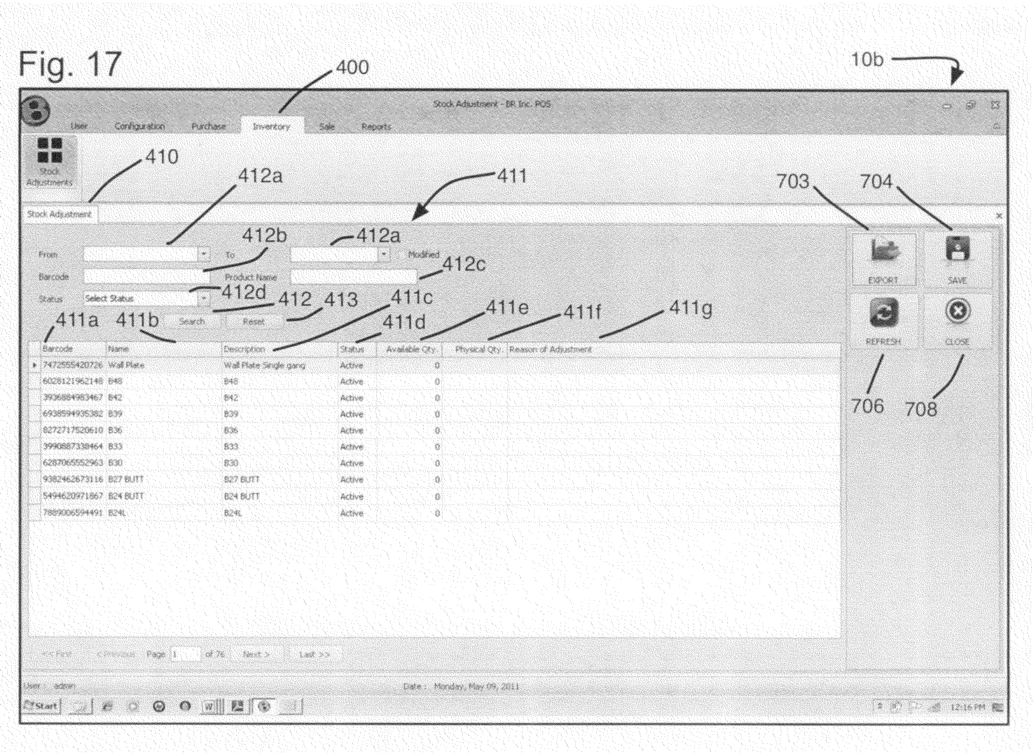

As illustrated in FIG. 17, the main Inventory Menu 400 contains the stock adjustment sub-menu 410. Upon selecting the stock adjustment sub-menu 410 the user can view on the screen 10b available goods in stock or make adjustments to the goods available in stock. The stock adjustment sub-menu 410 contains the stock adjustment data tree fields 411 of barcode field 411a, name field 411b, description field 411c, status field 411d, available quantity field 411e, physical quantity field 411f, and reason of stock adjustment field 411g. A contractor's user, either a back office administrator or a contractor's representative, can initiate a search 412 of stock adjustments in real time by entering information into the search fields of from/to creation date range filed 412a, barcode field 412b, product name field 412c, or status field 412d. A user may also reset a search 413 and enter in varied search information. Additionally, as illustrated in FIG. 17, while in the stock adjustment sub-menu 410 a user can perform operational functions by actuating the export button 703 to export a stock adjustment, save button 704 to save a stock adjustment, refresh button 706 to refresh the stock adjustment on the screen 10b, or the close button 708 to close the stock adjustment on the screen 10b.

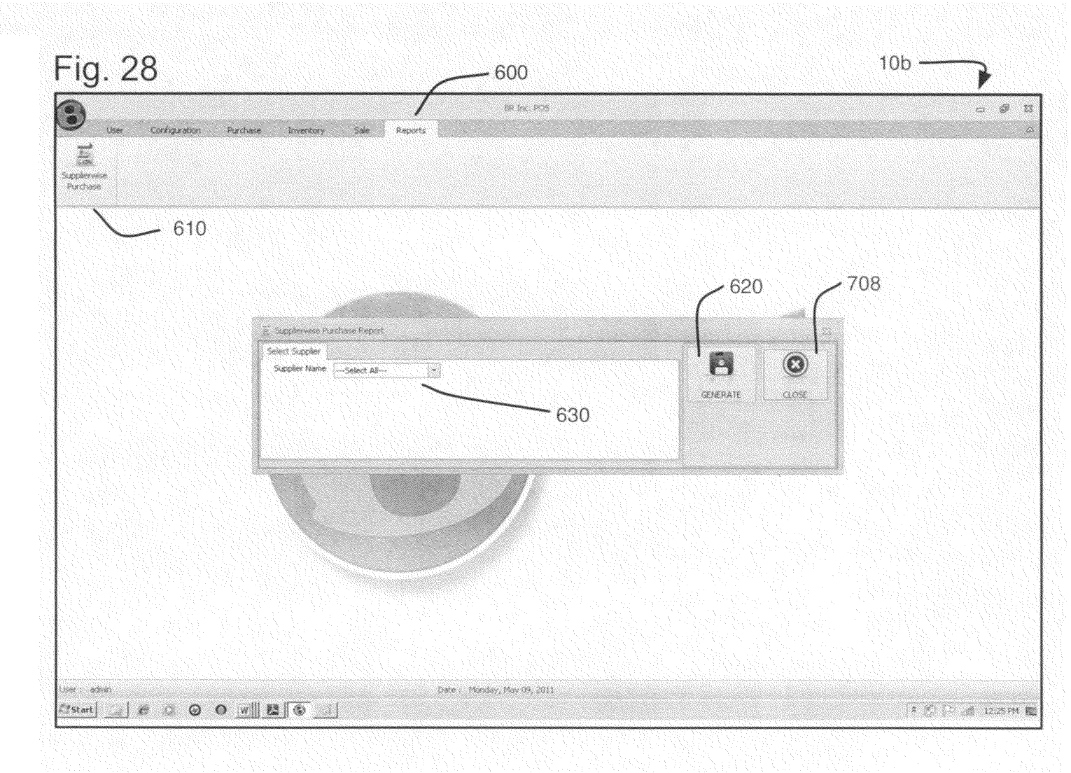

As illustrated in FIG. 28, the main Reports Menu 600 contains the supplierwise purchase sub-menu 610. Upon selecting the supplierwise purchase sub-menu 610 a user can generate a report of what goods and/or services have been purchased from a supplier 321c by accessing the generate button 620. Additionally, as illustrated in FIG. 28 while in the supplierwise purchase sub-menu 610 a user can access the close button 708 to close the supplierwise purchase sub-menu on the screen 10b.

### Real Time Software Application Specification

Once my computer program product has been configured and formatted to reflect an individual contractor's specific goods and services, a contractor's representative may take full advantage of the organized data and the operational features of my computer program product to create or modify in real time a quotation estimate or sales contract at a customer's job site. Appendix C shows a final formatted version of a quotation estimate which may be displayed on the screen 10b, printed, emailed, or faxed to a customer.

My computer program product has two main contractor users: a back office administrator and a contractor's representative who while at a job site prepares, in real time, a sale quotation and/or sale contact for a specific designated structure to be built at a customer's job site. Generally, the back office administrator will configure my computer program product to the specific operations of the company upon the back office system 11 (FIG. 2). The back office system 11 is a main computer hardware device, which, in part, runs my computer program product and then connects with and synchronizes the configured data with a contractor's representative's handheld portable computer apparatus 10. Some features of my computer program product can be open to manipulation or restricted and only allow the back office administrator to access, edit, or configure. For example, the contractor's representative may not enter in products (goods or services) and their associated prices points.

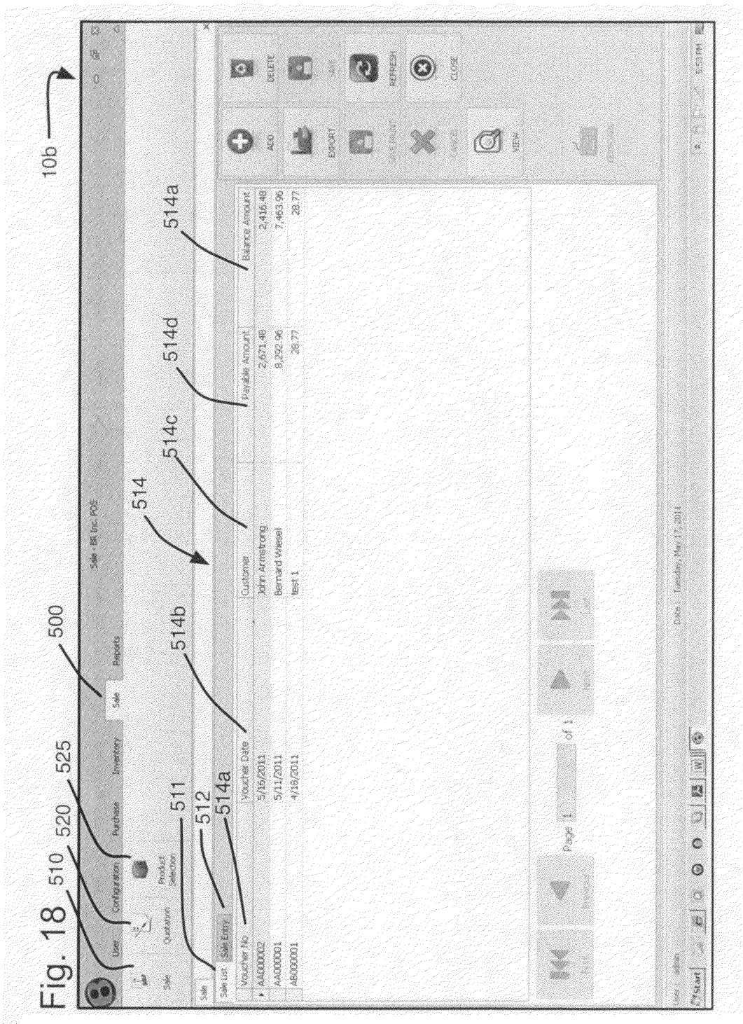

As illustrated in FIG. 4, upon any user launching my computer program product, the user must login 110 to the application by using a unique name 111 and password 112. As illustrated in FIG. 5, the User Menu 100 contains the logout sub-menu 113 and the exit sub-menu 114 allowing a contractor's representative to either logout of, or exit my computer program product. Upon arrival at a customer's job site the contractor's representative is able to interact with the customer and assess what task is to be carried out and what goods and/or services are required to carry out such a task. For example, a customer may require their house to be painted, which would require, at the very least paint goods and the services of a painter. Once the customer's required task is ascertained, the contractor's representative can display on the screen 10b the available products for the job, and then prepare a quotation estimate or a sale contract for the total cost of the job. As illustrated in FIG. 18, my computer program product contains the Sale Menu 500. The Sale Menu 500 contains the product selection sub-menu 525. As illustrated in FIG. 22, upon selecting the product selection sub-menu 525 the contractor's representative accesses the product selection superclass 526. While in the product selection superclass 526 the contractor's representative can view on the screen 10b all of the available products 230 by browsing the product image gallery 900. Additionally, the contractor's representative can search for a product by either product name 233b or by product barcode 233a. Once a specific product is ascertained the contractor's representative can then add the product to a sale contract by pushing the move to sale button 910. Likewise, the contractor's representative can add the product to a quotation estimate by pushing the move to quotation button 920.

After the contractor's representative discusses the job to be performed with the customer the customer may wish to receive a sale quotation estimate for the work to be performed. As illustrated in FIG. 21, the Sale Menu 500 contains the quotation sub-menu 520. Upon selecting the quotation sub-menu 520 the contractor's representative can access the quotation entry superclass 522. The quotation entry superclass 522 contains the quotation entry data tree fields 523 which allow the contractor's representative to prepare a quotation estimate for a customer by inputting such pertinent data into the quotation number field 523a, quotation date field 523b, customer's first name field 523c, customer's last name field 523d, address field 523e, city field 523f, state field 523g, contact phone number field 523h, email address field 523i, and notes field 523j. Additionally, as illustrated in FIG. 21, while in the quotation entry sub-menu 522 the contractor's representative can perform such operational functions by actuating the save button 704 to save a quotation entry, the save print button 705 to save and print a quotation entry, refresh button 706 to refresh the quotation entry on the screen 10b, cancel button 707 to cancel inputting a quotation entry, or the close button 708 to close the quotation entry appearing on the screen 10b. As depicted in FIG. 21, once the contractor's representative has entered in the customer's information in the data tree fields 523, the contractor's representative is able actuate the add field button 550 and add to the quotation entry superclass 522 the various products (goods and/or services) required to fulfill the customer's ascertained task.

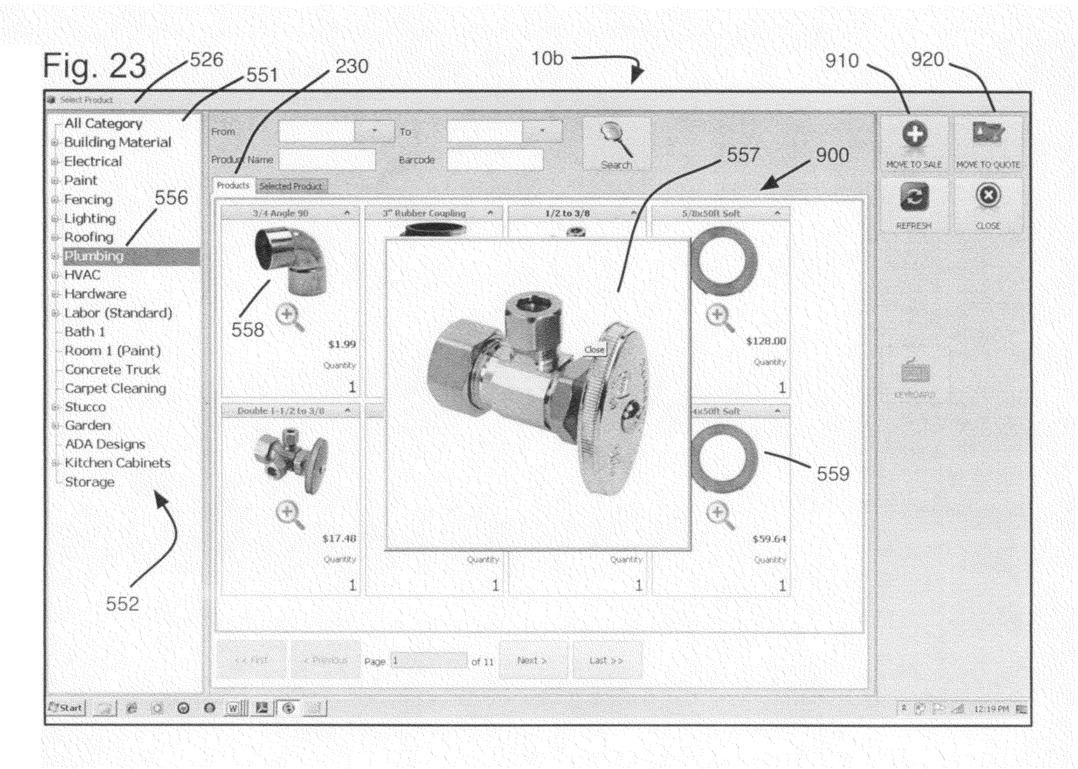

As depicted in FIG. 22, once the add button 550 is accessed the contractor's representative proceeds to the products selection superclass 526. While in the product selection superclass 526 the contractor's representative can view on the screen 10b all of the available products 230 in the product image gallery 900. Moreover, while in the product selection superclass 526 the contractor's representative can view on the screen 10b a list of the configured product categories in field 551, for example, building material products, electrical products, or painting products. The content for the categories in field 551 is from the saved data of the category entry data tree fields 212 and 213. Upon interacting with the customer and ascertaining the customer's specific task or job, the contractor's representative may then, in real time, select a specific pre-configured category from the category list field 552 and view goods in the product field 230 related to the chosen category from the category list field 552. For example, as illustrated in FIG. 23, the contractor's representative can view on the screen 10b all the pre-configured categories in field 551, ascertain a specific pre-configured category in field 552, and ultimately select a specific category task, such as plumbing in field 556. The contractor's representative can then, in real time, view available plumbing in field 556, and related goods in field 230 such as, a valve in field 557, a coupling in field 558, or a washer in field 559.

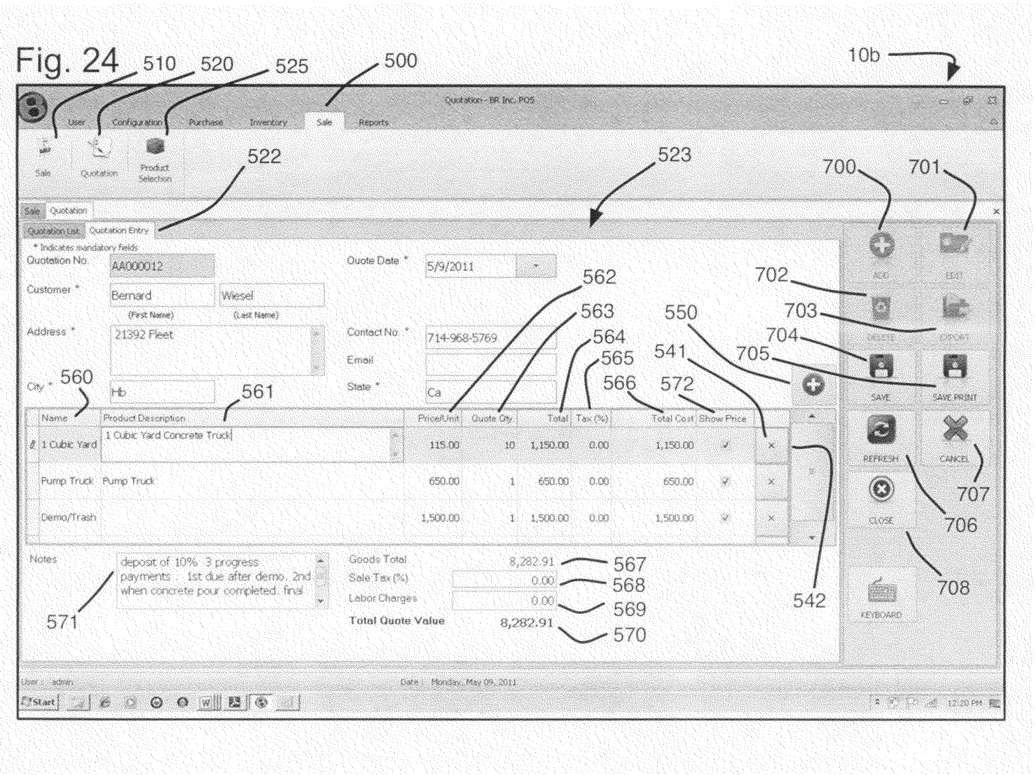

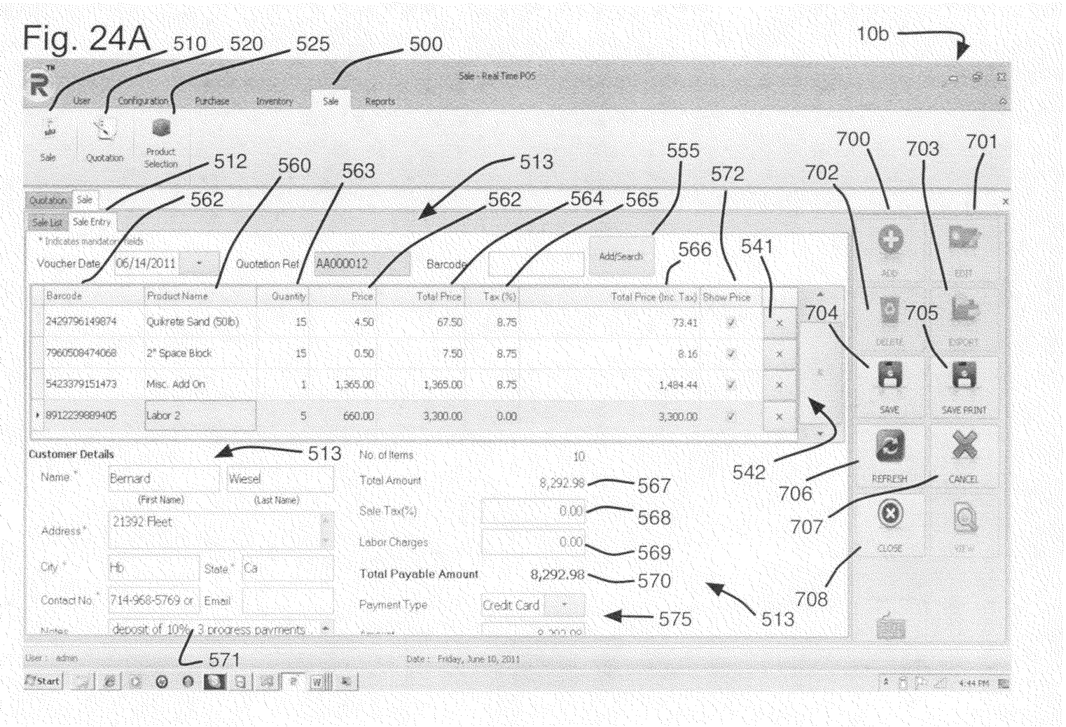

As illustrated in FIG. 24, once a quotation entry 522 is complete, through entering data in the quotation entry data tree fields 523, adding goods from field 550, and choosing specific goods or services from field 230 from a specific category in field 552, my computer program product displays and calculates in the quotation entry data tree fields 523, each selected good or service name in field 560, goods or services description for this selection in field 561, the selected goods or services price per unit in field 562, quote quantity in field 563, total goods or services cost in field 564, and tax (%) in field 565. The total cost including tax is displayed in field 566. The price of the good or service may be displayed or not displayed by checking or un-checking the show price filed 572. Whether to show the price of a selected good to the customer at this stage in negotiations is optional with the contractor's point of sale representative. My computer program product allows the contractor's point of sale representative to adjust the standard good or services price per unit in field 562 and then show the quotation entry fields 522 appearing on the screen 10b to the customer. Likewise, my computer program product allows the contractor's point of sale representative to add to the standard product description field 561. For example, if a products standard description appearing in field 561 states 2×4 lumber, the contractor's point of sale representative can modify the description to state 2×4 pressure treated lumber is required.

As illustrated in FIG. 24, my computer program product calculates the quantity and pricing of the entries made within a quotation entry 522, displaying on the screen 10b the goods total of the selected goods in field 567, the goods sale tax % in field 568, labor service charges in field 569, total quote value of goods and services in field 570, and any notes in field 571 relating to the specific quotation estimate. My computer program product allows for any products included in a completed quotation entry field 522 to be deleted in real time by touching the “x” button 541 at the end of the individual goods row 542.

As illustrated in FIGS. 25, 26, 27, a final contractor formatted quotation estimate 520A can be visually displayed, printed, emailed, or faxed, to the customer while at the customer's job site in real time. The formatted quotation estimate 520A includes all the configured company details in field 250, customer information in field 581, products description and total in field 582, and miscellaneous information in field 571, such as, deposit requirements that were inputted in the quotation entry superclass 522. A final contractor formatted quotation estimate 520A also includes the products subtotal field 567, sales tax field 568, labor charges field 569, and total cost field 570.

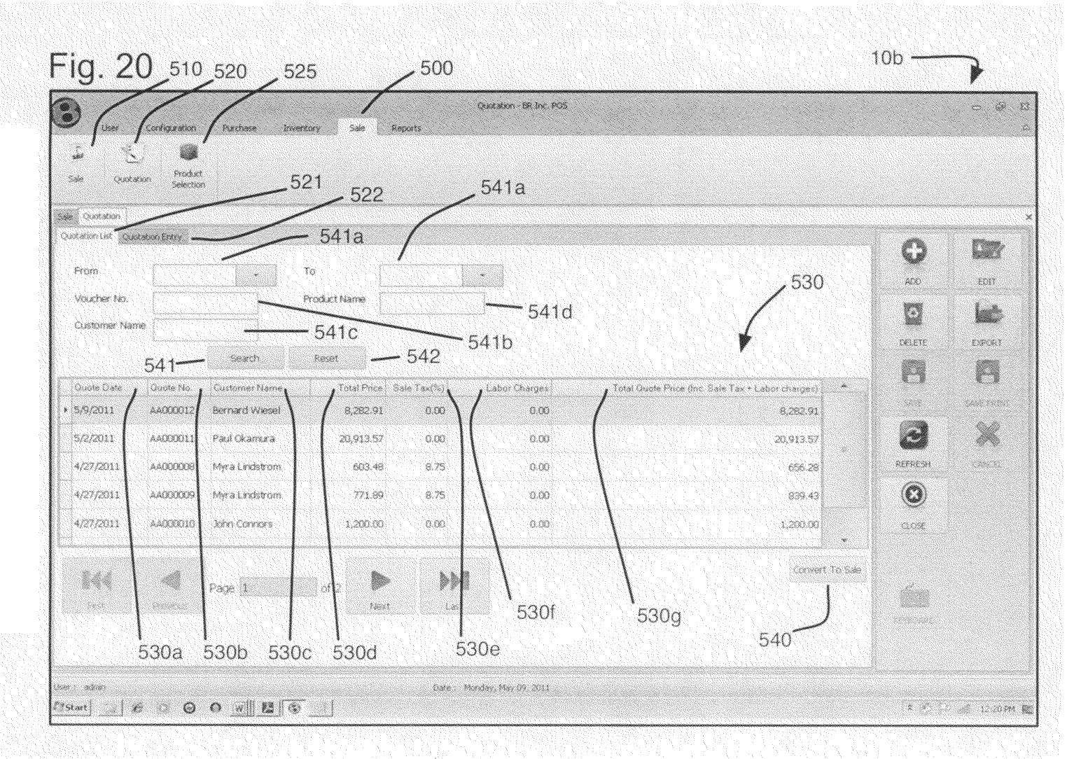

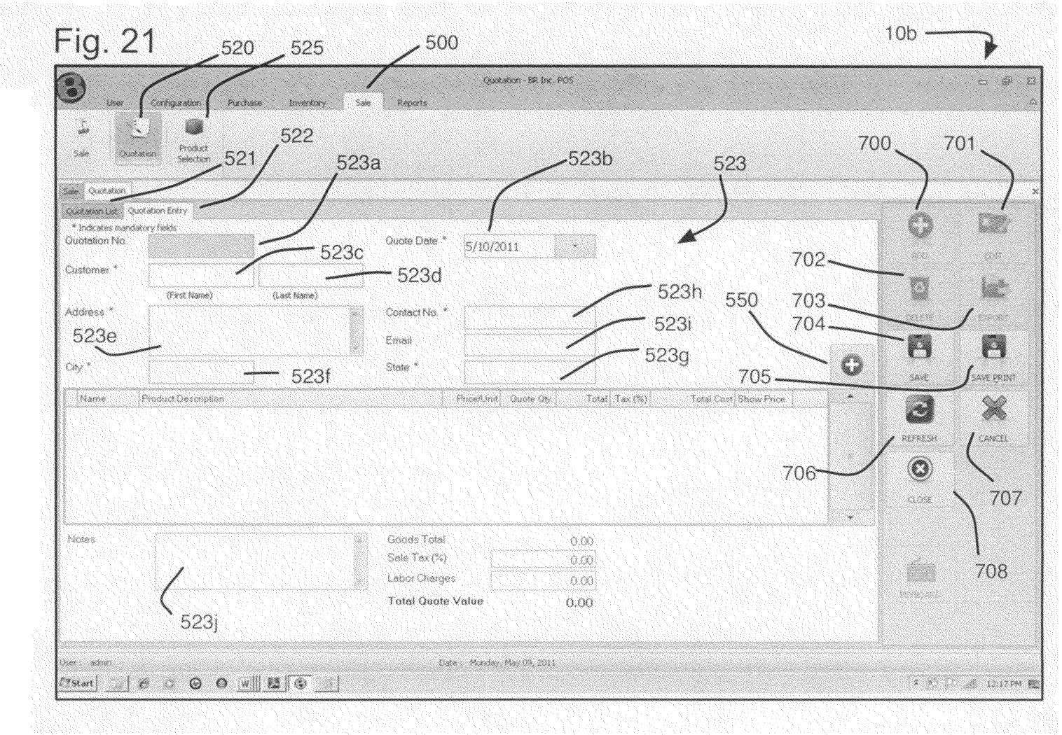

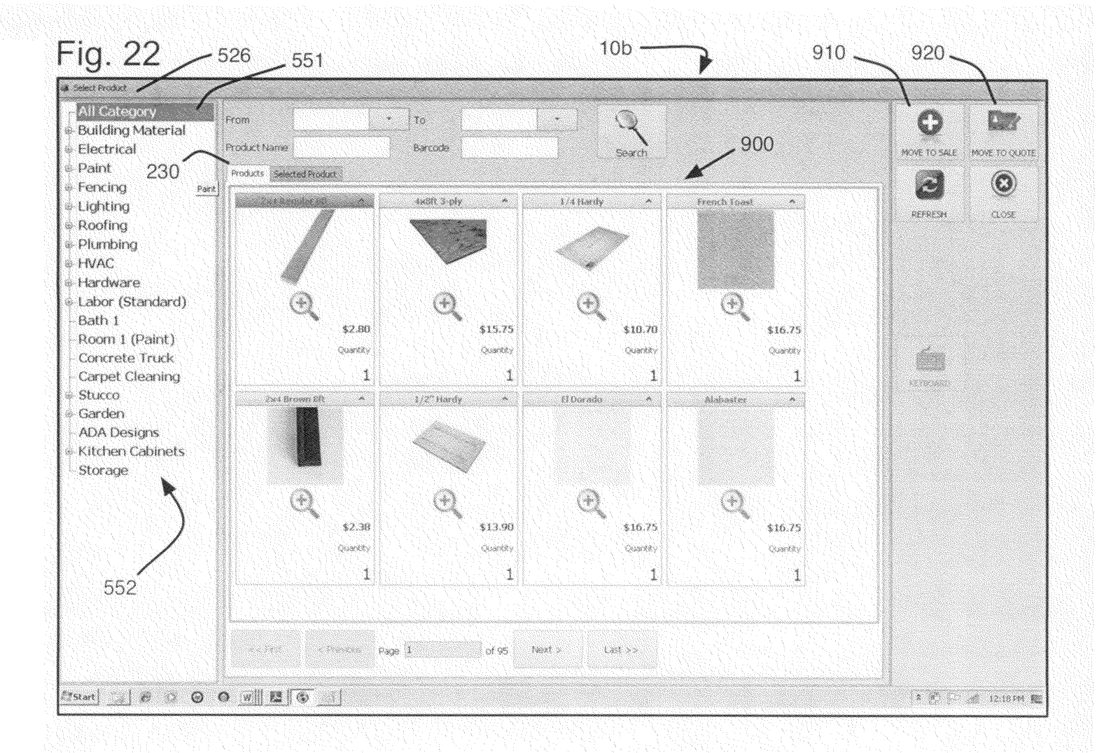

As illustrated in FIG. 20, the Sale Menu 500 contains the quotation list superclass 521. The quotation list 521 allows a contractor's representative to view a compiled list of all the saved quotation entries from the quotation entry superclass 522. The quotation list field 521 displays the quotation list data tree fields 530 of quote date field 530a, quote number field 530b, customer name field 530c, total price field 530d, sale tax (%) field 530e, labor charges field 530f, and total quote price field 530g. A contractor's user, either a back office administrator or a contractor's representative, can search field 541, the quotation list in field 521 in real time for a specific quotation entry in field 522 by entering information into the search fields of from/to creation date range field 541a, voucher number filed in field 541b, or customer name field 541c, or by goods name filed in field 541d. A user may also reset a search in field 542 and enter in varied search information. Additionally, my computer program product allows a contractor's representative to select a saved quotation entry from the quotation list in field 521 and convert in field 540 a sale quotation estimate in field 520 into a sale contract in field 510 ready for a customer's acceptance.

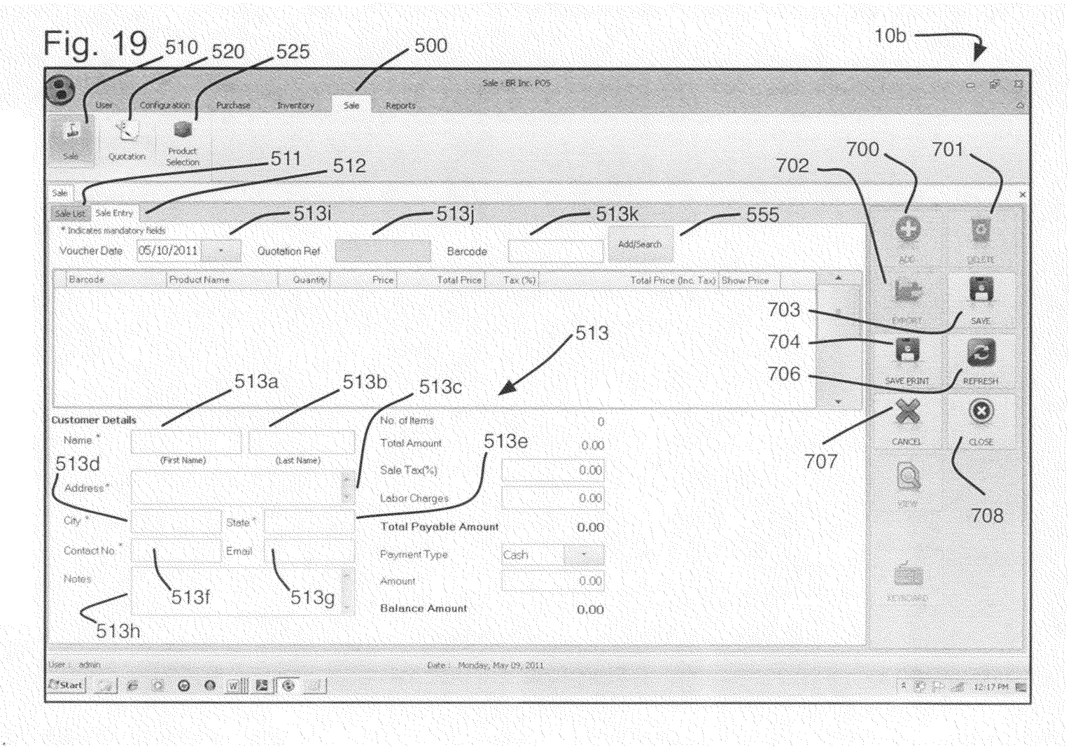

Once the contractor's representative ascertains the customer's requested job the contractor's representative is able to prepare a sale contract for the customer to enter into. As illustrated in FIG. 19, the Sale Menu 500 contains the sale sub-menu 510. Upon selecting the sale sub-menu 510 the contractor's representative accesses the sale entry superclass 512. The sale entry superclass 512 contains the sale entry data tree fields 513 which allow the contractor's representative to prepare a sale contract for a customer by inputting such pertinent data into the customer's first name field 513a, customer's last name field 513b, address field 513c, city field 513d, state field 513e, contact phone number field 513f, email address field 513g, and notes field 513h regarding the specific sale entry 512. The sale entry 512 data tree fields 513 also display a voucher date field 513i, a possible prior quotation reference number field 513j, and a barcode field 513k. Additionally, as illustrated in FIG. 19, while working on a sale entry sub-menu 512 the contractor's representative can perform such necessary operational functions by actuating the save button 704 to save a sale entry, save print button 705 to save and print a sale entry, refresh button 706 to refresh the sale entry on the screen 10b, cancel button 707 to cancel inputting a sale entry, or the close button 708 to close the sale entry appearing on the screen 10b.

As depicted in FIG. 19, once the contractor's representative has entered in the customer information in the data tree fields 513, the contractor's representative is able to add to the sale entry 512 the various products (goods and/or services) required to fulfill the customer's ascertained task. To add a product to a sale entry 512 the contractor's representative can enter a barcode for a specific product in the barcode field 513k. Likewise, by accessing the add/search button 555 the contractor's representative is able to add products to the sale entry 512 by proceeding to the products selection superclass 526. As depicted in FIG. 22, while in the product selection superclass 526 the contractor's representative can view on the screen 10b all of the available products 230 in the product image gallery 900. Moreover, while in the product selection superclass 526 the contractor's representative can view on the screen 10b a list of all the previously configured product categories in field 551 and sub categories 552, for example, building material products, electrical products, or painting products. The content for the categories is from the saved data of the category entry data tree fields 212 and 213. Upon interacting with the customer and ascertaining the customer's specific task or job, the contractor's point of sale representative may then, in real time, select a specific pre-configured category from the category list field 552 and view goods in the product field 230 related to the chosen category list field 552. For example, as illustrated in FIG. 23, the contractor's point of sale representative can view on the screen 10b all the pre-configured categories in field 551, ascertain a specific pre-configured or sub-category in field 552, and ultimately select a specific category task, such as plumbing in field 556. The contractor's point of sale representative can then, in real time, view available plumbing in field 556, related goods in field 230 such as, a valve in field 557, a coupling in field 558, or a washer in field 559.

As illustrated in FIG. 24A, once a sale entry 512 is complete, through entering data in the sale entry data tree fields 513, adding products from field 550, and choosing specific products from field 230 from a specific category in field 552, my computer program product displays and calculates in the sale entry data tree fields 513, each selected product's name in the product name field 560, the selected goods or services price per unit in field 562, quantity in field 563, total goods or services cost in field 564, and tax (%) in field 565. The total cost including tax is displayed in field 566. The price of the product may be displayed or not displayed by checking or un-checking the show price field 572. Whether to show the price of a selected good to the customer at this stage in negotiations is optional with the contractor's point of sale representative. Should a customer wish to delete a product from the sale entry 512 my computer program product allows for any products included in a completed sale entry 512 to be deleted in real time by accessing the “x” button 541 at the end of the individual goods row 542.

As illustrated in FIG. 24A, my computer program product calculates the quantity and pricing of the entries within the sale entry fields 512, displaying on the screen 10b the goods total of the selected products in field 567, the goods sale tax % in field 568, labor service charges in field 569, total quote value of goods and services in field 570, and any notes in field 571 relating to the specific quotation estimate. The contractor's representative can show the completed sale entry 512 appearing on the screen 10b to the customer at such time, or perhaps ask for a varying greater price that may be reduced if the customer refuses to buy at the elevated price over that shown in the sale entry 512. At this point, my computer program product, enables a contractor's representative to change, in real time, the predetermined standard prices of either goods or services 562, whereby the contractor's representative has the ability to close a sale at the customer's job site. Whether to adjust the price of a selected goods or services is optional with the contractor's point of sale representative.

As illustrated in FIG. 30, once a customer accepts the sale contract the contractor's representative can enter into the payment field 575 a form and amount of payment the customer will apply to start the requested job. For example, the contractor's representative can enter into the payment type field 576 whether cash, check, or credit will be applied to the total amount due. Then the contractor's representative can enter into the amount field 577 the amount of payment the customer is applying towards the amount due and the presented sale contract will reflect the final amount due in the balance amount field 578.

As illustrated in FIGS. 25A, 26A, 27A, a final contractor formatted sale contract 510A can be visually displayed, printed, emailed, or faxed, to the customer while at the customer's job site in real time. The final contractor formatted sale contract 510A includes all the configured company details in field 250, customer information in field 581, products description and total in field 582, and miscellaneous information in field 571, such as, deposit requirements that were inputted in the sale entry superclass 512. A final contractor formatted sale contract 510A also includes the products subtotal field 567, sales tax field 568, labor charges field 569, total cost field 570, amount paid towards balance field 577, and balance amount due field 578.

As illustrated in FIG. 18, the Sale Menu 500 contains the sale list superclass 511. The sale list 511 allows a contractor's representative to view a compiled sale list of all the saved sale entries from the sale entry superclass 512. The sale list in field 511 displays the sale list data tree fields 514 of voucher number in field 514a, voucher date in field 514b, customer in field 514c, payable amount in field 514d, and balance amount in field 514e. Additionally, my computer program product allows a contractor's representative to select a sale entry in field 512 from the sale list in field 511 to view and/or modify at a later time.

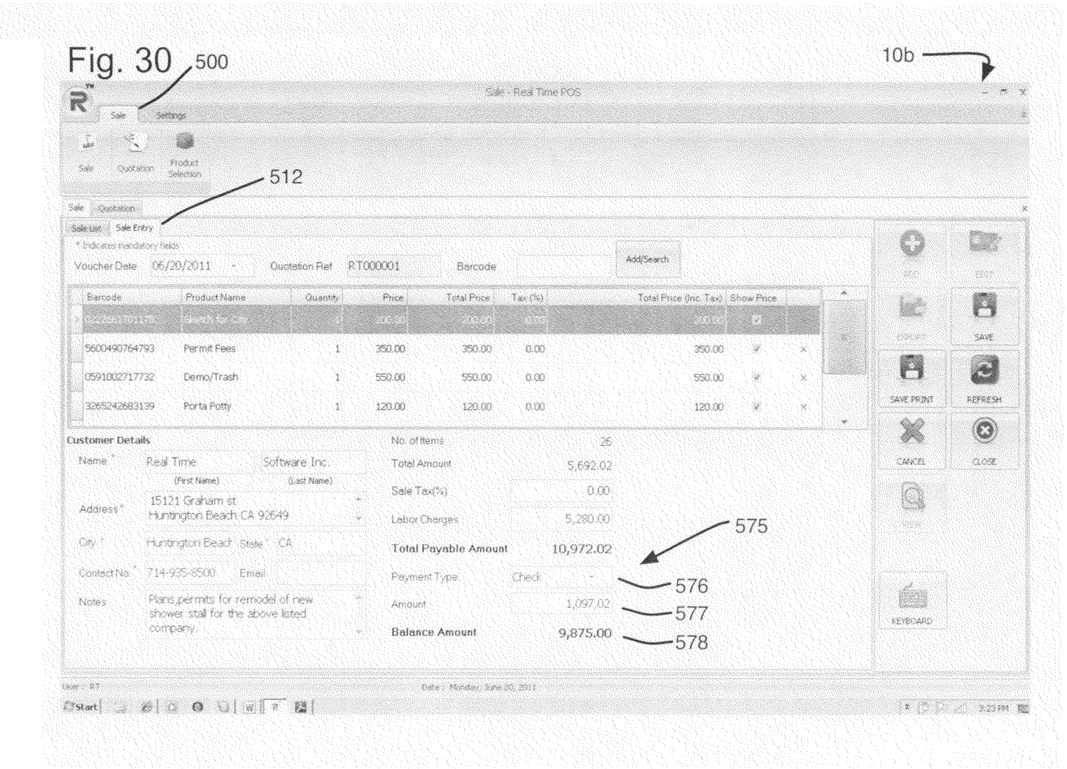

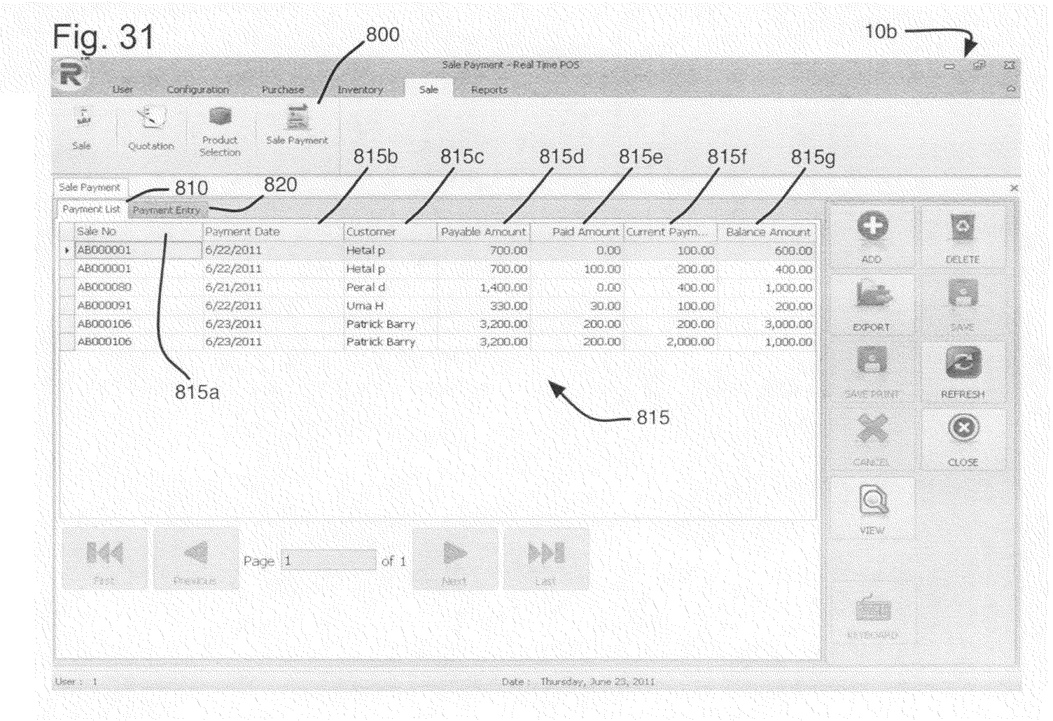

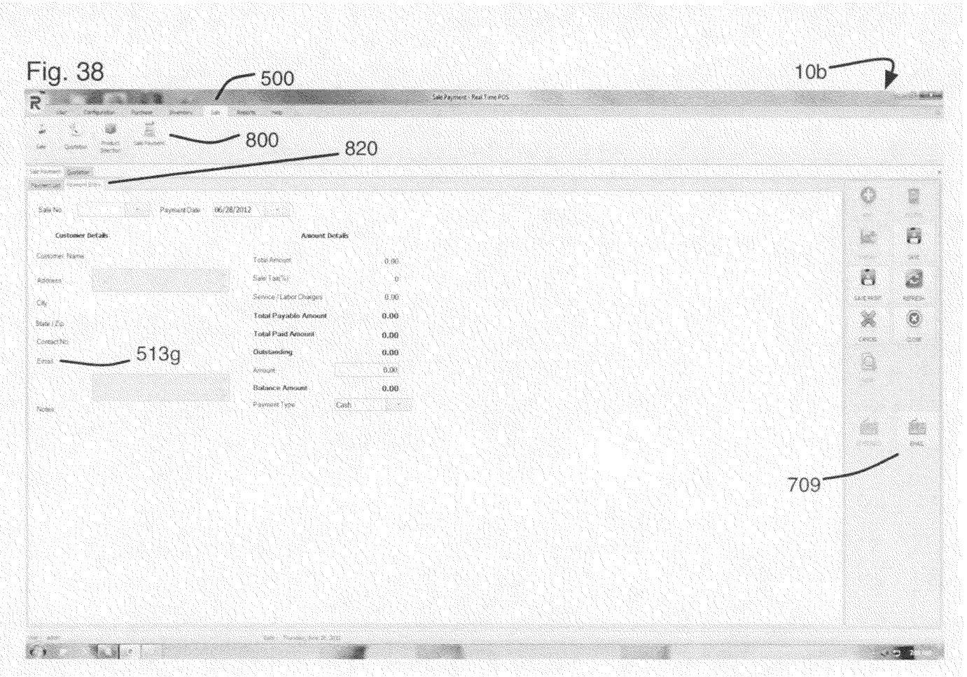

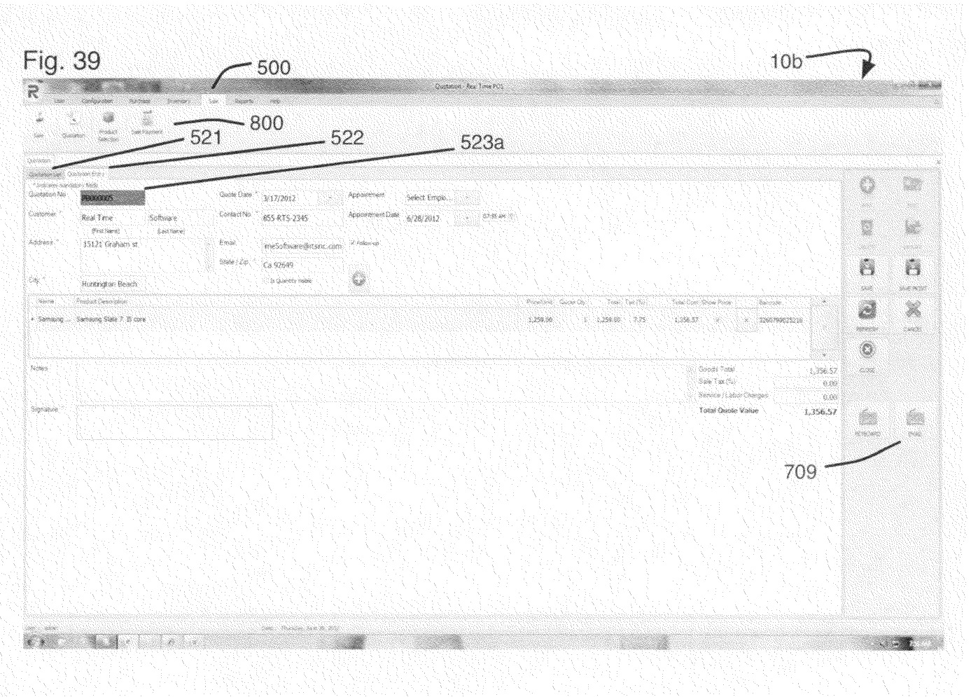

As illustrated in FIG. 31, the Sale Menu 500 contains the sale payment submenu 800. The sale payment submenu 800 allows the contractor's representative or back office administrator to access either the payment list superclass 810 or the payment entry superclass 820. As illustrated in FIG. 32, the payment entry superclass 820 allows the contractor's representative or back office administrator to apply payments towards the final balance due on a customer's specific job. The contractor's representative or back office administrator can choose which account to apply a payment towards by selecting a job from the sale number field 827. Once a specific job has been selected the payment entry data tree fields 825 allow the contractor's representative or back office administrator to apply payments towards the final balance due by inputting or importing the amount to be applied in the amount field 825a. Once a payment has been entered the remaining amount due will be reflected in the balance amount field 826. As illustrated in FIG. 38 the payment entry superclass 820 contains the one touch email button 709. The one touch email button 709 allows the contractor's representative to send various emails directly from the REAL TIME SOFTWARE computer program product without having to first export the information for attachment in an external email application. For example, when a customer has submitted a form of payment the contractor's representative can then send a copy of the payment receipt to the customer's email address originally entered in the email address field 513g (see FIG. 19). As illustrated in FIG. 39 the quotation superclass 522 contains the one touch email button 709. Here, the one touch email button 709 allows the contractor's representative to choose a specific quotation number from the quotation number field 523a and email the associated quotation estimate to a customer directly from the REAL TIME SOFTWARE computer program product. The payment list superclass 810 allows a contractor's representative or back office administrator to view a compiled payment list of all the saved payment entries 820. The payment list 810 displays on the screen 10b the payment list data tree fields 815 of sale number field 815a, payment date field 815b, customer name field 815c, payable amount field 815d, payment amount 815e, current payment field 815f, and balance amount field 815g. Thus, while viewing the payment list superclass 810, one can quickly ascertain the total payable amount due for a particular job, how much has been paid towards the completion of the job, the amount and date of the most recent payment, and the total balance due on a particular job.

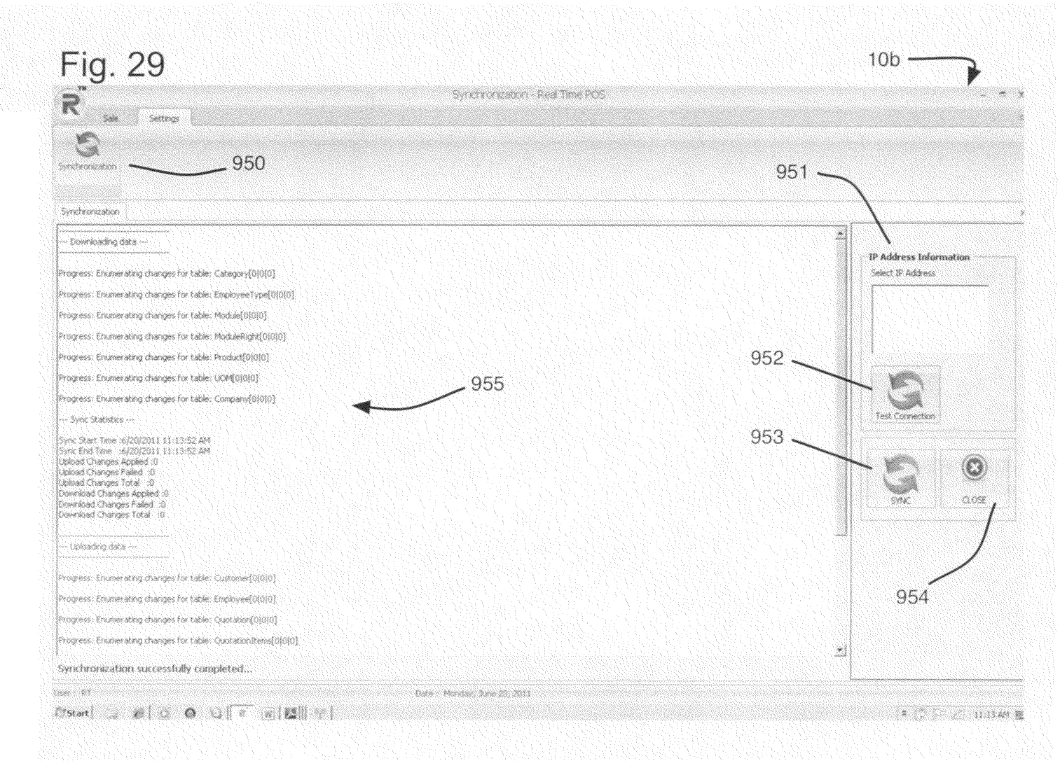

Once a sale quotation estimate or sale contract is complete the contractor's representative can synchronize the representative's computer apparatus 10 with the back office system 11. The synchronization function updates quotation and sale details and will also update the product details and available stock from the back office system 11 to the contractor's representative's computer apparatus 10. As illustrated in FIG. 29, the synchronization submenu 950 contains the IP address information field 951, test connection button 952, synchronize button 953, and close synchronization submenu button 954. To initiate the synchronization function the contractor's representative first enters or selects an IP address in the IP address information field 951. The IP address is a numerical label assigned to each device in a computer network, for example the back office system 11. Once the correct IP address for the back office system 11 is entered the contractor's representative can test the connection by accessing the test connection button 952. Should the connection be correct the contractor's representative can then start the synchronization process by accessing the synchronize button 953. Once synchronization has begun, the data transfer field 955 will display on the screen 10b the quotation, sale, or product details that need to be updated. After synchronization is successfully completed the contractor's representative can close the synchronization submenu 950 by accessing the close submenu button 954.

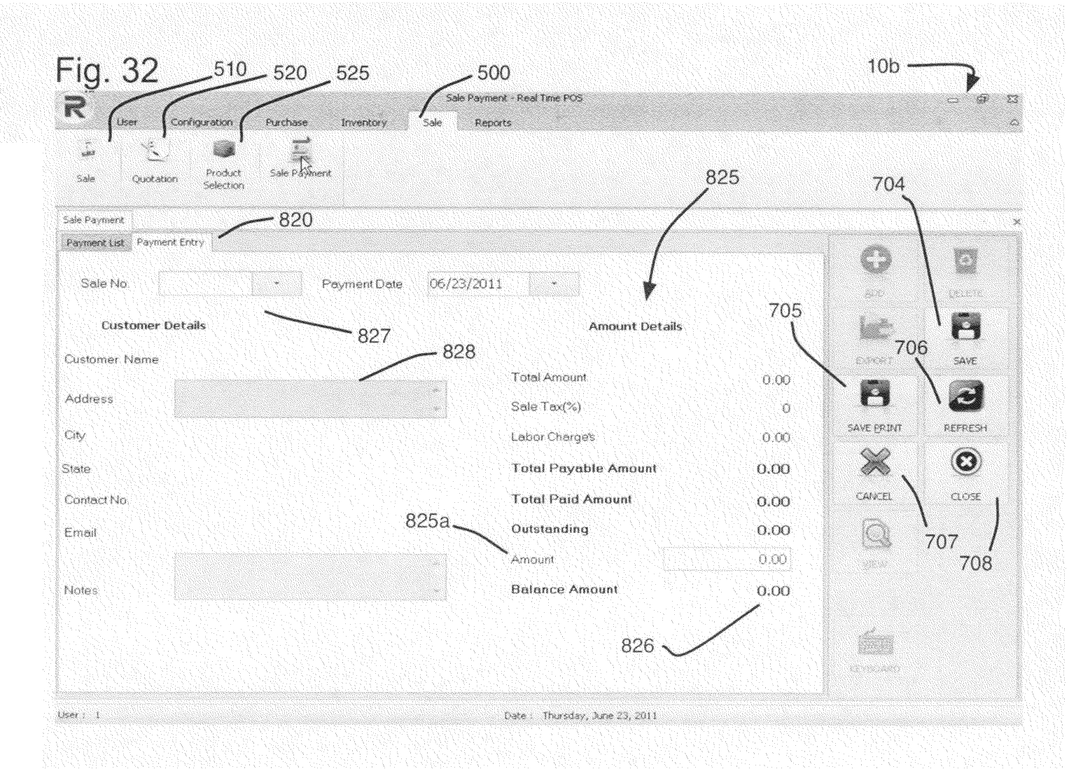

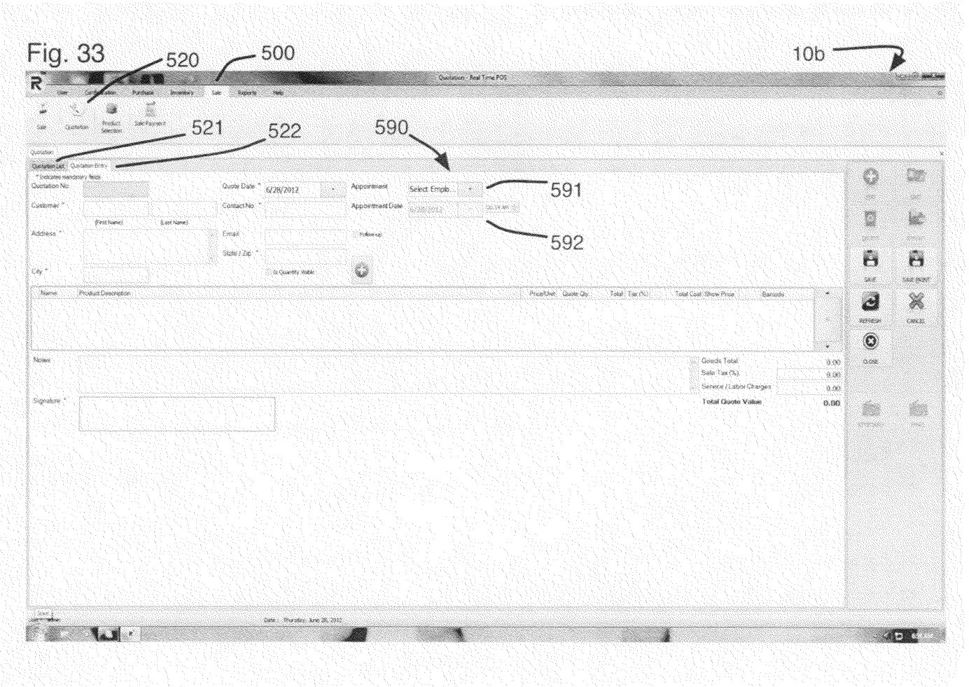

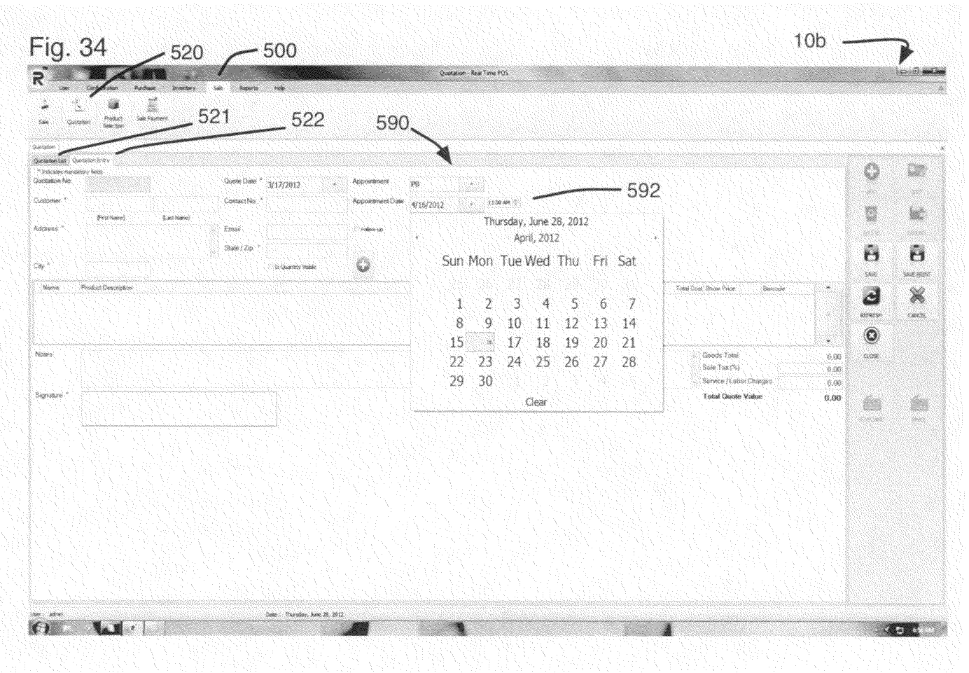

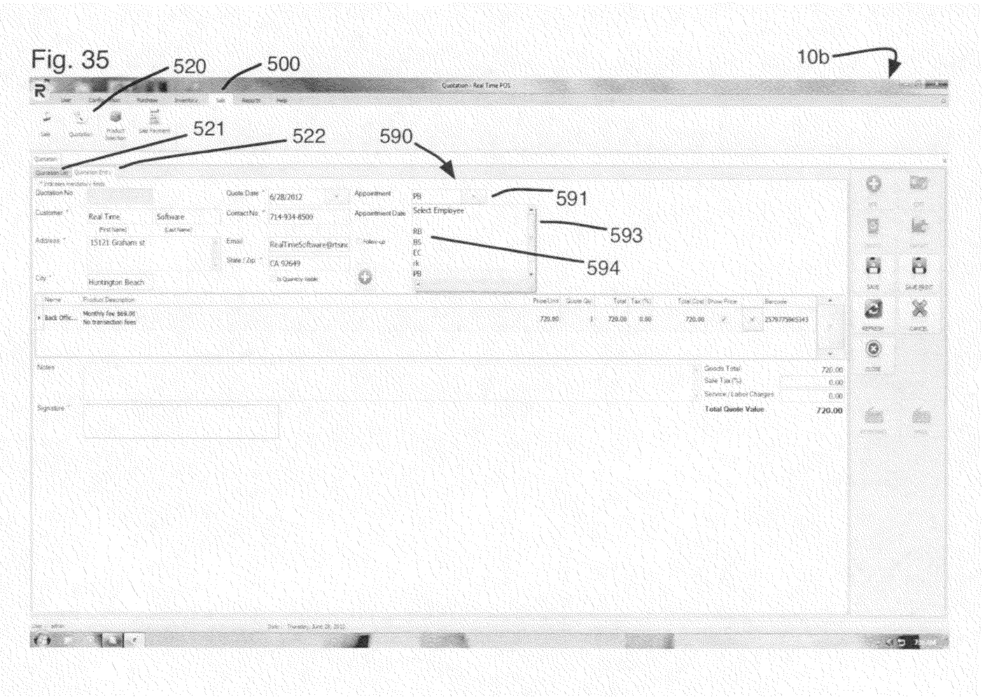

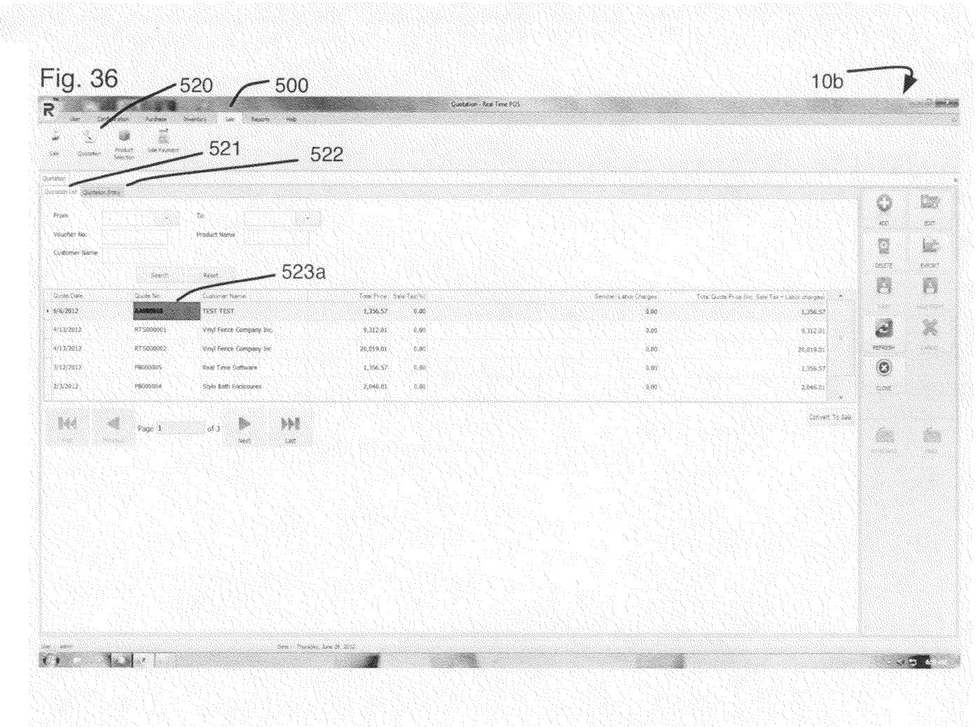

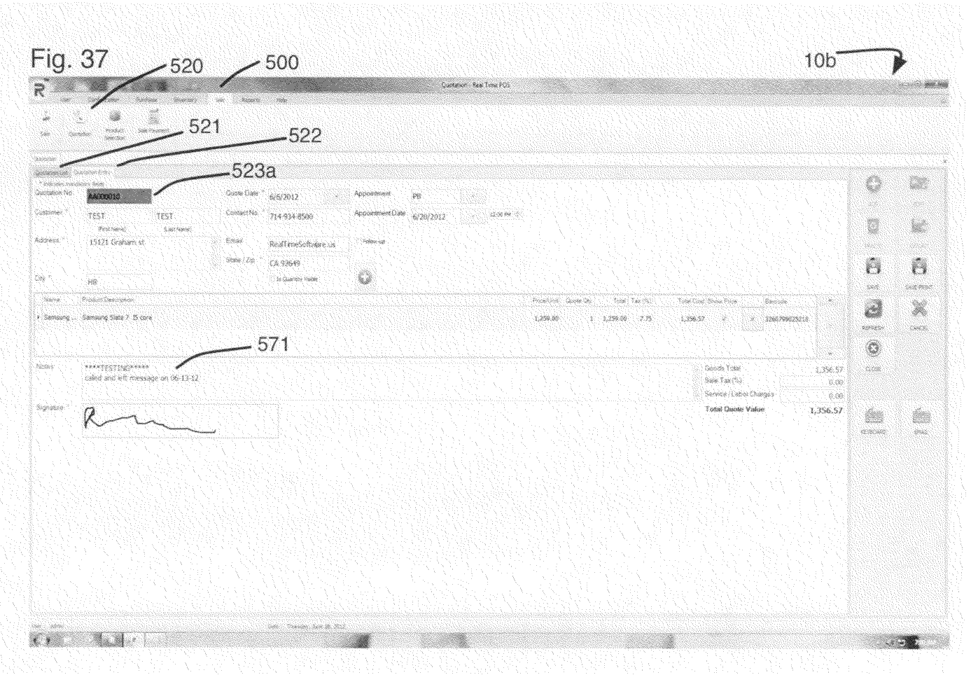

As illustrated in FIG. 33 the quotation entry superclass 522 contains the appointment field 590. The appointment field 590 includes the select employee assignment field 591 and appointment time selection field 592. As illustrated in FIG. 35 a back office administrator can use the select employee assignment field 591 to assign a specific contractor's representative to meet with a customer at a customer's job site. The select employee field 591 includes a drop down box 593 for choosing the specific contractor's representative by their initials 594. As illustrated in FIG. 34 while a contractor's representative is inputting data in the quotation entry superclass 522 the contractor's representative may use the appointment time selection field 592 to schedule a day and time to meet with a customer at a customer's job site. When the contractor's representative accesses the synchronize button 953 (FIG. 29) the contractor's representative's computer apparatus 10 will synchronize all newly entered appointments and updated sales and quotation entry information with the back office system 11. As illustrated in FIG. 36 once a quotation estimate has been entered the quotation list 521 allows a contractor's representative to view a compiled list of all the saved quotation entries. Here, the customer's quotation number field 523a will change color in order to reflect whether any follow up activity has been imitated between the contractor's representative and a customer. For example, during the first week of entering a quotation estimate the quotation number field 523a will have no additional color. Then, when a second week with no follow up activity arises, the quotation number field 523a will change from no color to yellow. Finally, when a third week with no follow up activity arises, the quotation number field 523a will change from yellow to red. As illustrated in FIG. 37 the contractor's representative can make follow up contact with a customer and then make detailed notes in the note field 571. Additionally, after the contractor's representative makes follow up contact with a customer the contractor's representative can reset the quotation number field 523a to green status for an additional three week period.

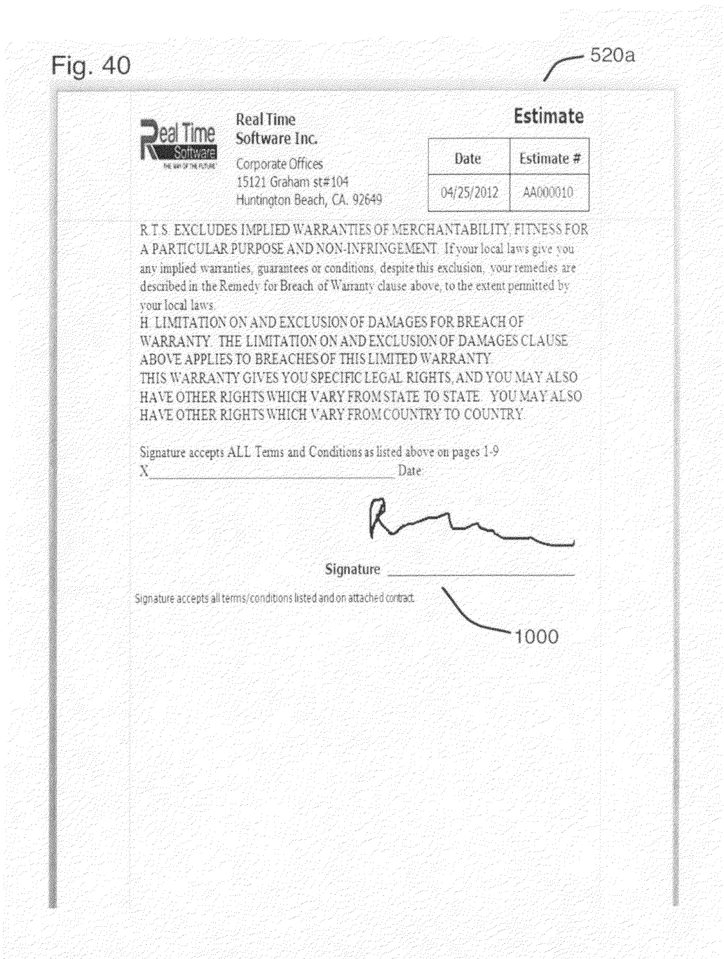

As illustrated in FIG. 40 the customer's signature 1000 can be digitally captured onto the computer apparatus 10, stored in the data base memory of the computer apparatus 10 and then displayed on a final contractor formatted quotation estimate 520A or a final contractor formatted sale contract 510A (not shown).

### SCOPE OF THE INVENTION

The above presents a description of the best mode I contemplate of carrying out my computer apparatus and product for and method of determining the price of construction services at a job site, and of the manner and process of making and using them in such full, clear, concise, and exact terms as to enable a person skilled in the art to make and use. My computer apparatus and product for and method of determining the price of construction services at a job site are, however, susceptible to modifications and alternate constructions from the illustrative embodiment discussed above which are fully equivalent. Consequently, it is not the intention to limit my computer apparatus and product for and method of determining the price of construction services at a job site to the particular embodiment disclosed. On the contrary, my intention is to cover all modifications and alternate constructions coming within the spirit and scope of my computer apparatus and product for and method of determining the price of construction services at a job site as generally expressed by the following claims, which particularly point out and distinctly claim the subject matter of my invention:

1. A portable, handheld computer apparatus for determining the price of construction services at a job site in real time for presentation to a customer, comprising
an input device,
a display screen,
a memory including stored data providing costs of a plurality of different construction materials and/or components used in building a designated structure at a customer's job site including at least some visual images of different construction materials and/or components to be upon selection displayed on the display screen to enable a customer to see the image and make a selection of specific materials and/or components at the job site upon viewing the images, and
a program that based at least in part upon the specific materials and/or components selected determines a total cost and a profit, enabling a contractor's representative while at a job site and in real time to quote a price to the customer for the construction services.

2. The apparatus of claim 1 where the program enables the contractor's representative to enter other information about the job site and/or the designated structure as additional factors in determining the total cost and the profit.

3. The apparatus of claim 1 including means for enabling the contractor's representative to communicate with a remote back office computer for recording sales transactions in a memory of the back office computer.

4. The apparatus of claim 3 where the back office computer is programmed for managing types of goods and/or services being offered for sale and an inventory of goods.

5. The apparatus of claim 3 where the back office computer is programmed for scheduling a meeting of a contractor's representative with a customer while the contractor's representative is at a location remote from the back office computer and the time and location of the scheduled meeting are displayed on the display screen.

6. The apparatus of claim 3 including means for synchronizing the back office computer with the memory in the apparatus to update data in said memory in the apparatus.

7. The apparatus of claim 3 where the means for enabling the contractor's representative to communicate with the remote back office computer comprise a global computer network.

8. The apparatus of claim 1 where the input device is incorporated into the screen so that a selection of a goods is made by touching an image of a good displayed on the screen.

9. The apparatus of claim 1 where the size of an image can be increased or decreased.

10. The apparatus of claim 1 where the costs can be shown or hidden from view of a customer.

11. A sales system comprising
(a) a portable, handheld computer apparatus adapted to be carried to a customer's job site by a contractor's representative, said computer apparatus including
a display screen,
a stored data providing costs of a plurality of different construction materials and/or components used in building a designated structure at the customer's job site including at least some visual images of different construction materials and/or components to be upon selection displayed on the display screen to enable a customer to see the image and make a selection of specific materials and/or components at the job site upon viewing the images,
said computer apparatus having a program that based at least in part upon the specific materials and/or components selected determines a total cost and a profit, enabling a contractor's representative while at the job site and in real time to quote a price to the customer for the construction services for presentation to the customer, and
(b) a remote back office computer adapted to be placed in communication with the handheld computer apparatus for recording sales transactions in a memory of the back office computer.

12. The system of claim 11 where the program enables the contractor's representative to enter other information about the job site and/or the designated structure as additional factors in determining the total cost and the profit.

13. The system of claim 11 where the back office computer is programmed for managing types of goods and/or services being offered for sale and an inventory of goods.

14. The system of claim 11 where the back office computer is programmed for scheduling a meeting of a contractor's representative with a customer while the contractor's representative is at a location remote from the back office computer and the time and location of the scheduled meeting are displayed on the display screen.

15. The system of claim 11 including means for synchronizing the back office computer with the memory in the apparatus to update data in said memory in the apparatus.

16. The system of claim 11 where the means for enabling the contractor's representative to communicate with the remote back office computer comprise a global computer network.

17. The system of claim 11 where the handheld computer apparatus includes an input device incorporate into the screen so that a selection of a goods is made by touching an image of a goods displayed on the screen.

18. A business method comprising
providing a contractor's representative with a portable, handheld communication device having a visual display for showing a customer images of a variety of different materials and/or components for building a variety of different types of structures,
a contractor's representative meeting a customer at a job site where a designated structure is to be built,
while at the job site said representative using the communication device to display on the visual display for viewing by the customer images of the variety of different materials and/or components from which is selected the specific materials and/or components for building the designated structure at the job site,
said customer while at the job site selecting from the displayed images which specific materials and/or components that correspond at least in part to those to be used in building said designated structure, and
while at the job site entering the customer's selection of materials and/or components into the communication device, which is programmed to determine a total cost and a profit, displaying on the visual display a price to enable the contractor's representative while at the job site and in real time to quote to a price to the customer for the services to build the designated structure.

19. The business method of claim 18 where the visual display of the handheld communication device includes an input device incorporate into the display so that a selection of a goods is made by touching an image of a goods being displayed.

20. The business method of claim 19 where a remote back office computer is adapted to be placed in communication with the handheld communication device for recording sales transactions in a memory of the back office computer.

21. The business method of claim 20 where the back office computer is programmed for scheduling a meeting of a contractor's representative with a customer while the contractor's representative is at a location remote from the back office computer and the time and location of the scheduled meeting are displayed on the display screen.

22. A computer program product for controlling a handheld, portable computer to execute a program that determines sales prices, said computer program product comprising routines that
(a) enables a contractor's representative in real time at a meeting with a customer at a location remote from a contractor's office to offer for sale a combination of goods and services required to install or use the goods,
(b) enables a customer to view images of multiple goods and select one or more goods to be purchased, at least some of the selected goods having predetermined standard prices,
(c) calculates a total cost and a profit based at least in part on the predetermined standard prices, enabling a contractor's representative while at a job site and in real time to quote a sales price to the customer based at least in part upon a goods selected by a customer, and
(d) enables a contractor's representative to change said predetermined standard prices, whereby said contractor's representative has the ability to close a sale at the remote location in real time.

23. The computer product of claim 22 including a routine that enables a contractor's representative to convert a quote into firm price and a contract ready for a customer's acceptance.

24. The computer product of claim 22 where at least some of the goods have associated therewith a standard description and the computer product includes a routine that enables a contractor's representative to change at least some of said standard descriptions.
